(19) United States
(12) Patent Application Publication
(10) Pub. No.: US 2016/0345331 A1
(43) Pub. Date: Nov. 24, 2016

(54) WIRELESS COMMUNICATION SYSTEM, BASE STATION, WIRELESS TERMINAL, AND PROCESSING METHOD IMPLEMENTED BY BASE STATION

(71) Applicant: FUJITSU LIMITED, Kawasaki-shi (JP)

(72) Inventor: Takashi Seyama, Kawasaki (JP)

(73) Assignee: FUJITSU LIMITED, Kawasaki-shi (JP)

(21) Appl. No.: 15/080,785

(22) Filed: Mar. 25, 2016

(30) Foreign Application Priority Data
May 19, 2015 (JP) 2015-102159

(51) Int. Cl. H04W 72/04; H04B 7/04; H04W 52/34

(52) U.S. Cl. CPC H04W 72/0473; H04W 52/34; H04B 7/0413

(57) ABSTRACT

A wireless communication system includes a base station and a plurality of wireless terminals that are capable of wirelessly communicating with the base station. The base station includes: a plurality of wireless apparatuses that form a plurality of cells; and a first processor configured to execute a first process including: determining a transmission power level for each of the cells in such a manner that a value obtained by totaling values of indexes for the plurality of cells becomes largest, the indexes each indicating a degree of fairness in communication opportunities among wireless terminals in a corresponding one of the plurality of cells. Each of the plurality of wireless terminals includes: a second processor configured to execute a second process including receiving, in a cell in which wireless terminals are present, a signal from each of the plurality of wireless apparatuses by using the transmission power level of the cell.

### CROSS-REFERENCE TO RELATED APPLICATION

This application is based upon and claims the benefit of priority of the prior Japanese Patent Application No. 2015-102159, filed on May 19, 2015, the entire contents of which are incorporated herein by reference.

### FIELD

The embodiments discussed herein are related to a wireless communication system, a base station, a wireless terminal, and a processing method implemented by a base station.

### BACKGROUND

An Orthogonal Frequency Division Multiple Access (OFDMA) method has been used in downlink communication of a 3rd Generation Partnership Project (3GPP) Long Term Evolution (LTE) system, which is a typical example of a fourth-generation mobile communication system. The OFDMA method is a type of Orthogonal Multiple Access (OMA) methods. FIG. 17A is a chart illustrating a method for allocating sub-bands according to the OFDMA method. According to the OFDMA method, as illustrated in FIG. 17A, when a base station schedules data for a plurality of wireless terminals (UE #1 and UE #2), sub-bands that are orthogonal to each other are allocated, in order to prevent interference between the wireless terminals from occurring in the same time period.

In contrast, in a fifth-generation mobile communication system, a method called Non-Orthogonal Multiple Access (NOMA) method is under consideration by which a base station allocates non-orthogonal resources that interfere with each other, to a plurality of wireless terminals. FIG. 17B is a chart illustrating a method for allocating sub-bands according to the NOMA method. As illustrated in FIG. 17B, according to the NOMA method, a base station allocates the same sub-band to two wireless terminals (UE #1 and UE #2) by using a predetermined ratio of electric power allocation (hereinafter, “power allocation”). For example, a NOMA system having a Successive Interference Canceller (SIC) function has been proposed by which a terminal demodulates and decodes a signal addressed thereto after cancelling signals addressed to the other terminal which may cause an interference because the plurality of wireless terminals are multiplexed on the same resources at the same time.

According to the NOMA method, the base station selects two wireless terminals (users) that are namely a wireless terminal U1 being positioned close to the base station and having a high Signal-to-Noise Ratio (SNR) and a wireless terminal U2 being positioned distant from the base station and having a low SNR. Because the SNR of the wireless terminal U2 is lower than the SNR of the wireless terminal U1, the Modulation and Coding Scheme (MCS) value for a signal addressed to the wireless terminal U2 is arranged to be lower. For this reason, the wireless terminal U1 is able to succeed in demodulating and decoding the signal addressed to the wireless terminal U2 with a high possibility. Consequently, by cancelling the signal addressed to the wireless terminal U2 on which the demodulation and decoding processes have successfully been performed from the reception signal, the wireless terminal U1 is able to reduce the impact of the interference caused by the signal addressed to the wireless terminal U2.

In contrast, the wireless terminal U2 experiences a significant impact of the interference caused by the signal addressed to the wireless terminal U1. However, because the SNR of the wireless terminal U2 is low as mentioned above and because there are significant impacts of other interference noises, the impact of the interference caused by the signal addressed to the wireless terminal U1 is relatively small. FIG. 18 is a chart illustrating the difference in capacities of the wireless terminals U1 and U2 between the OFDMA method and the NOMA method. In FIG. 18, the x-axis defines the capacity of the wireless terminal U1 (unit: bits/s/Hz), whereas the y-axis defines the capacity of the wireless terminal U2 (unit: bits/s/Hz). Further, in FIG. 18, the SNR of the wireless terminal U1 is assumed to be 20 dB, whereas the SNR of the wireless terminal U2 is assumed to be 0 dB. As illustrated in FIG. 18, because the data corresponding to the NOMA method indicated by the solid line is constantly positioned to the upper right of the data corresponding to the OFDMA method indicated by the broken line, it is understood that the capacities of the wireless terminals U1 and U2 are constantly higher when the NOMA method is used than when the OFDMA method is used and that the system performance is improved.

Non-Patent Document 1: A. Benjebbour, Y. Saito, Y. Kishiyama, A. Li, A. Harada, and T. Nakamura “Concept and Practical Considerations of Non-orthogonal Multiple Access (NOMA) for Future Radio Access”, the International Symposium on Intelligent Signal Processing and Communication Systems (ISPACS) 2013, November 2013.

In this regard, as a method for scheduling wireless resources implemented by a base station to determine how much of the resources is allocated to which of the wireless terminals belonging to the cells thereof, a Proportional Fair (PF) scheduling method is known by which the degree of fairness among the wireless terminals is taken into consideration. Even in systems implementing the NOMA method, it is possible to maximize a PF utility value (a logarithmic sum of average throughputs of the wireless terminals) which is an index for the degree of fairness, by performing the PF scheduling process. However, when the PF scheduling process confined to each of the cells is performed, even if the PF utility value for each cell is maximized, the PF utility value for all the cells including the other cells is not necessarily maximized.

### SUMMARY

According to an aspect of the embodiments, a wireless communication system includes a base station and a plurality of wireless terminals that are capable of wirelessly communicating with the base station. The base station includes: a plurality of wireless apparatuses that form a plurality of cells; and a first processor configured to execute a first process including: determining a transmission power level for each of the cells in such a manner that a value obtained by totaling values of indexes for the plurality of cells becomes largest, the indexes each indicating a degree of fairness in communication opportunities among wireless terminals in a corresponding one of the plurality of cells. Each of the plurality of wireless terminals includes: a second processor configured to execute a second process including receiving, in a cell in which wireless terminals are present, a signal from each of the plurality of wireless apparatuses by using the transmission power level of the cell determined at the determining.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a wireless communication system according to a first embodiment;

FIG. 2 is a block diagram illustrating a functional configuration of a base station according to the first embodiment;

FIG. 3 is a block diagram illustrating a functional configuration of a wireless terminal according to the first embodiment;

FIG. 4 is a block diagram illustrating a functional configuration of a scheduler unit included in the base station according to the first embodiment;

FIG. 5 is a block diagram illustrating a functional configuration of a centralized controller included in the base station according to the first embodiment;

FIG. 6 is a block diagram illustrating a hardware configuration of the base station;

FIG. 7 is a block diagram illustrating a hardware configuration of one of the wireless terminals;

FIG. 8 is a flowchart for explaining an inter-user power allocation re-optimizing process performed by the centralized controller included in the base station according to the first embodiment;

FIG. 9 is a flowchart for explaining an inter-user power allocation re-optimizing process performed by a centralized controller included in a base station according to a first modification example;

FIG. 10 is a block diagram illustrating a functional configuration of a base station according to a second embodiment;

FIG. 11 is a block diagram illustrating a functional configuration of a wireless terminal according to the second embodiment;

FIG. 12 is a block diagram illustrating a functional configuration of a centralized controller included in a base station according to a third embodiment;

FIG. 13 is a block diagram illustrating a functional configuration of a scheduler unit included in the base station according to the third embodiment;

FIG. 14 is a flowchart for explaining an average cell transmission power optimizing process performed by the centralized controller included the base station according to the third embodiment;

FIG. 15 is a block diagram illustrating a functional configuration of a centralized controller included in a base station according to another mode of the third embodiment;

FIG. 16 is a block diagram illustrating a functional configuration of a scheduler unit included in the base station according to the other mode of the third embodiment;

FIG. 17A is a chart illustrating a method for allocating sub-bands according to an OFDMA method;

FIG. 17B is a chart illustrating a method for allocating sub-bands according to a NOMA method; and

FIG. 18 is a chart illustrating the difference in capacities of wireless terminals between the OFDMA method and the NOMA method.

### DESCRIPTION OF EMBODIMENTS

Preferred embodiments will be explained with reference to accompanying drawings. The wireless communication system, the base station, the wireless terminal, and the processing method implemented by a base station disclosed herein are not limited to the exemplary embodiments.

### [a] First Embodiment

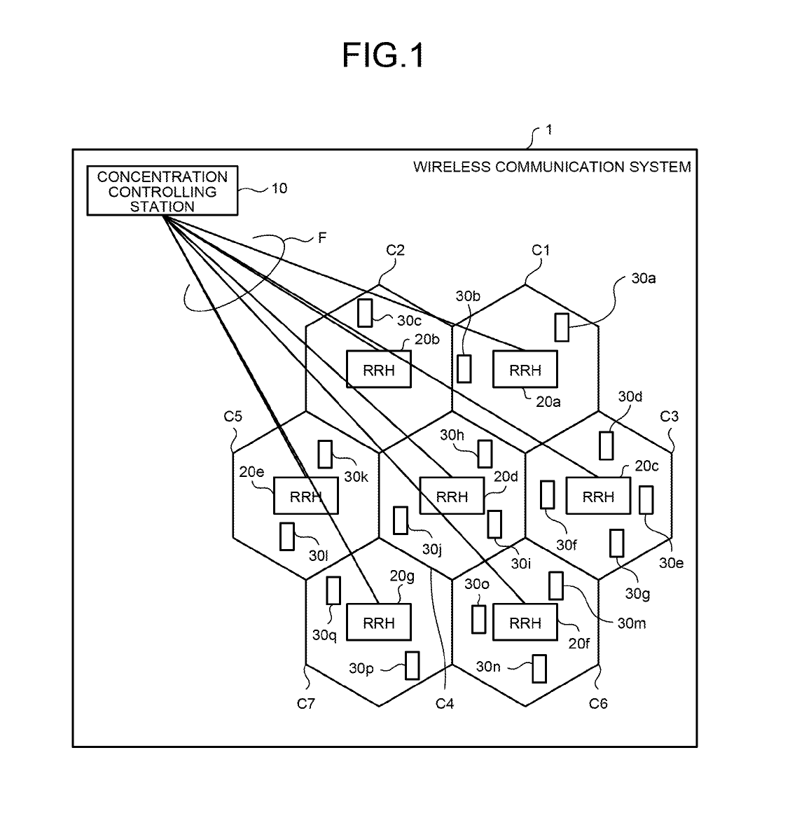

A configuration of a wireless communication system according to an embodiment of the present disclosure will be explained below. FIG. 1 is a diagram illustrating a configuration of a wireless communication system 1 according to a first embodiment. As illustrated in FIG. 1, the wireless communication system 1 includes a concentration controlling station 10, a plurality of Remote Radio Heads (RRHs) 20a to 20g, and a plurality of wireless terminals 30a to 30q. The concentration controlling station 10 is connected to the plurality of RRHs 20a to 20g via optical fibers F. The RRHs 20a to 20g form cells C1 to C7, respectively, and wirelessly communicate with the wireless terminals 30a to 30q that are present in the cells C1 to C7.

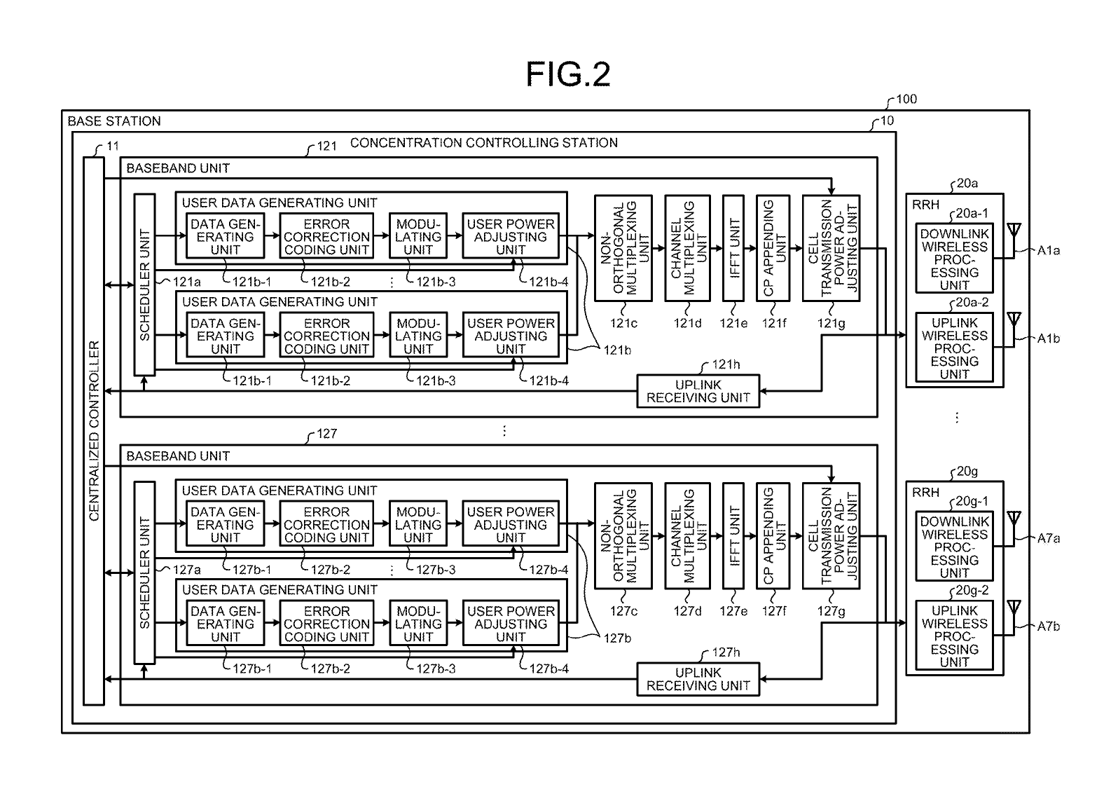

FIG. 2 is a block diagram illustrating a functional configuration of a base station 100 according to the first embodiment. As illustrated in FIG. 2, the base station 100 includes the concentration controlling station 10 and the RRHs 20a to 20g. Further, the concentration controlling station 10 includes a centralized controller 11 that controls functional units of the base station 100 in an integrated manner, as well as baseband units 121 to 127 each of which is in charge of a baseband processing process performed on a corresponding one of the cells C1 to C7.

The baseband unit 121 is connected to the RRH 20a configured to perform a wireless processing process on the cell C1, by an optical fiber F. The RRH 20a includes a downlink-signal transmission antenna Ala and a downlink wireless processing unit 20a-1, as well as an uplink-signal reception antenna A1b and an uplink wireless processing unit 20a-2. Although FIG. 2 illustrates an example in which one transmission antenna and one reception antenna are provided for each cell, two or more transmission antennas and/or two or more reception antennas may be provided for each cell. The RRH 20a receives an uplink signal transmitted from a wireless terminal (e.g., the wireless terminal 30a) via the reception antenna A1b and converts the received uplink signal into a baseband signal by employing the uplink wireless processing unit 20a-2. The uplink baseband signal is transferred to the concentration controlling station 10 via the optical fiber F, so that an uplink receiving unit 121h performs thereon processes such as a demodulating process and an error correction decoding process, and the like. Further, the uplink receiving unit 121h extracts an Ack/Nack signal and channel quality information called Channel State Information (CSI) contained in the uplink signal.

Although the details will be explained later, a scheduler unit 121a determines one or more wireless terminals (a plurality of wireless terminals when using the NOMA method) to which resources are to be allocated at a predetermined time, the electric power level (hereinafter, “power level”) of each of the wireless terminals, and a Modulation and Coding Scheme (MCS) value of each of the wireless terminals. Further, the scheduler unit 121a notifies the centralized controller 11 of the wireless terminals to which the resources are to be allocated and the power level of each of the wireless terminals. The centralized controller 11 determines the transmission power level of the cell C1 based on the results in the notification.

A user data generating unit 121b generates user data of the wireless terminal users designated by the scheduler unit 121a by employing a data generating unit 121b-1. An error correction coding unit 121b-2 performs an error correction coding process on the user data by using a wireless-terminal-user-specific coding rate designated by the scheduler unit 121a. A modulating unit 121b-3 modulates the user data by using a modulating method designated by the scheduler unit 121a. A user power adjusting unit 121b-4 adjusts the power level allocated to the user data to be transmitted to the user, so as to be equal to the power level designated by the scheduler unit 121a.

A non-orthogonal multiplexing unit 121c multiplexes the pieces of power-adjusted data of the plurality of wireless terminals designated by the scheduler unit 121a. A downlink control signal generating unit (not illustrated) generates a control signal for controlling the MCS value, the power level, and the like of each of the user wireless terminals. A channel multiplexing unit 121d multiplexes the non-orthogonally multiplexed user data and the control signal. An Inverse Fast Fourier Transform (IFFT) unit 121e converts the user data and the control signal that were multiplexed, into an effective symbol by performing an inverse fast Fourier transform thereon. A Cyclic Prefix (CP) appending unit 121f appends a CP to the effective symbol, so as to generate an Orthogonal Frequency Division Multiplexing (OFDM) symbol. A cell transmission power adjusting unit 121g controls the transmission power level of each of the cells (e.g., the cell C1) by controlling the power level of the transmission signal output from the baseband unit 121 so as to be equal to the power level indicated in the notification from the centralized controller 11. In this situation, the transmission power adjusting process may be carried out on the RRH 20a side, instead of on the concentration controlling station 10 side.

The RRH 20a converts the digital transmission signal output from the baseband unit 121 into an analog signal by employing the downlink wireless processing unit 20a-1. Further, by employing the downlink wireless processing unit 20a-1, the RRH 20a up-converts the analog-converted transmission signal so as to have the wireless frequency of the abovementioned OFDM symbol and transmits the result to a wireless terminal (e.g., the wireless terminal 30a) via the transmission antenna Ala.

The configurations of the baseband unit 121 and the RRH 20a have thus been explained as examples. Configurations of the other baseband units 122 to 127 and the other RRHs 20b to 20g are the same as those of the baseband unit 121 and the RRH 20a. Accordingly, the constituent elements that are the same as one another will be referred to by using the reference characters having the same endings, and illustrations with drawings and detailed explanations thereof will be omitted.

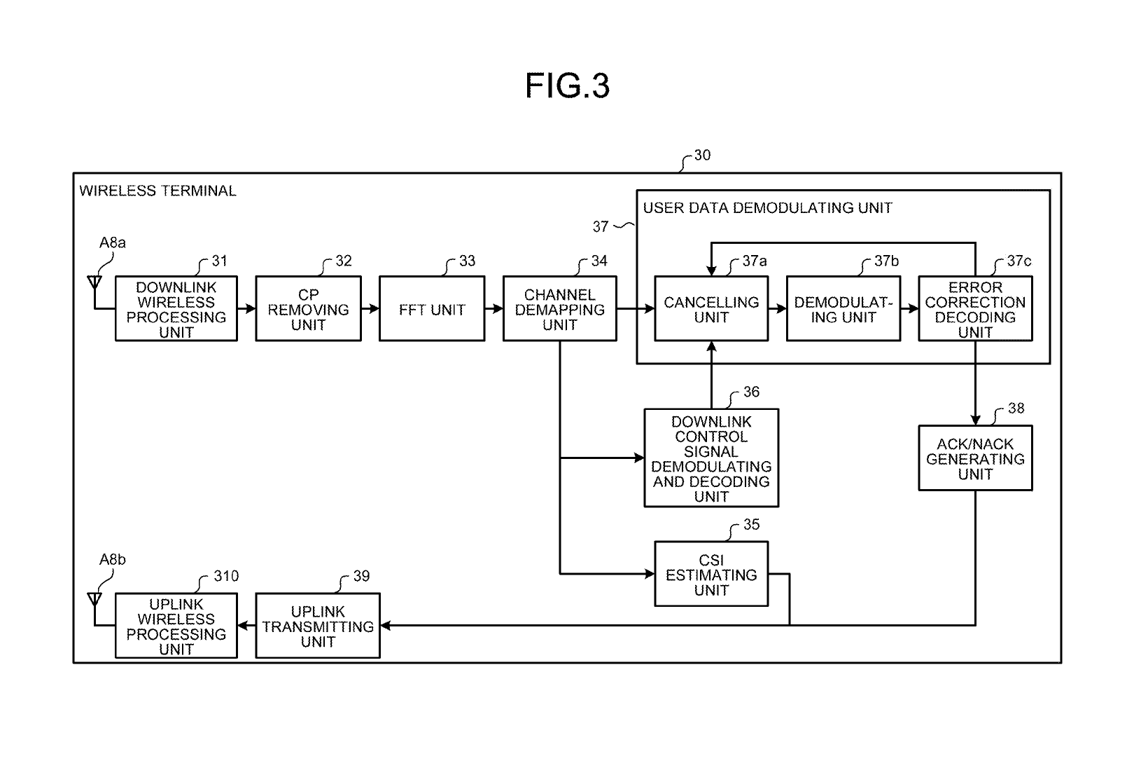

FIG. 3 is a block diagram illustrating a functional configuration of a wireless terminal 30 according to the first embodiment. As illustrated in FIG. 3, a downlink wireless processing unit 31 down-converts the signal having the wireless frequency received via a receiving antenna A8a to a baseband signal. After that, the downlink wireless processing unit 31 converts the down-converted analog reception signal into a digital signal. A CP removing unit 32 removes the CP from the received OFDM symbol so as to obtain the effective symbol. A Fast Fourier Transform (FFT) unit 33 converts the effective symbol into a signal in a frequency region by performing a fast Fourier transform thereon. A channel demapping unit 34 extracts the control signal from the signal converted into the signal in the frequency region and outputs the extracted control signal to a CSI estimating unit 35 and a downlink control signal demodulating and decoding unit 36. Although the details will be explained later, the CSI estimating unit 35 estimates channel quality information (a CSI value). The downlink control signal demodulating and decoding unit 36 demodulates the received control signal so as to obtain the information about the MCS value and the power level of each of the users contained in the control signal.

A user data demodulating unit 37 includes a cancelling unit 37a, a demodulating unit 37b, and an error correction decoding unit 37c. The cancelling unit 37a cancels any non-orthogonal multiplex user. When only the wireless terminal 30 of its own is the target of the allocating process (i.e., when there is no other non-orthogonal multiplex user besides the terminal of its own), the user data demodulating unit 37 skips the process performed by the cancelling unit 37a. After that, the user data demodulating unit 37 obtains the user data intended for the terminal of its own, as a result of a demodulating process performed by the demodulating unit 37b and an error correction decoding process performed by the error correction decoding unit 37c. In contrast, when there is one or more other non-orthogonal multiplex users besides the terminal of its own, the user data demodulating unit 37 performs a demodulating process and an error correction decoding process on such a non-orthogonal multiplex user of which the MCS value is smaller than the MCS value of the terminal of its own and that has the smallest MCS value. When the error correction decoding process has successfully been performed, the user data demodulating unit 37 cancels the corresponding user data from the reception signal, by employing the cancelling unit 37a.

The user data demodulating unit 37 thereafter repeatedly performs the demodulating process, the error correction decoding process, and the cancelling process described above on each of the non-orthogonal multiplex users of which the MCS value is smaller than the MCS value of the terminal of its own, in ascending order of the MCS values. As a result, when the user data processing process has been completed on all of the non-orthogonal multiplex users of which the MCS value is smaller than the MCS value of the terminal of its own, the user data demodulating unit 37 performs a demodulating process and an error correction decoding process on the user data of the terminal of its own.

When the error correction decoding process has successfully been performed on the user data of the terminal of its own, an Ack/Nack generating unit 38 generates an Ack signal. When the error correction decoding process performed on the user data of the terminal of its own has failed, the Ack/Nack generating unit 38 generates a Nack signal. An uplink transmitting unit 39 performs an error correction coding process and a modulating process on the uplink user data, the Ack/Nack signal, and the channel quality information (CSI). An uplink wireless processing unit 310 converts the digital transmission signal and the like resulting from the coding process and the modulating process into an analog signal and further up-converts the analog-converted signal so as to have a wireless frequency and transmits the result to the base station 100 via a transmission antenna A8b.

Next, a process performed by the CSI estimating unit 35 will be explained in detail. On the assumption that the number of transmission antennas of each of the cells C1 to C7 is 1 and that the number of reception antennas for the wireless terminals 30a to 30q is Nᵣₓ, it is possible to express a reception signal of a k-th user (wireless terminal) connected to an i-th cell, by using Expression (1) below, where i and k are each a natural number.

$${y}_{i , k} = {h}_{i , k , i} {x}_{i} + {\sum }_{j = 1 , j \neq i}^{N} {h}_{i , k , j} {x}_{j} + n \qquad ( 1 )$$

In Expression (1), y_{i,k} denotes a reception signal vector for Nᵣₓ×1. Further, h_{i,k,j} denotes the channel vector for Nᵣₓ×1 between the k-th user connected to the i-th cell and a j-th cell, whereas xⱼ denotes a transmission signal of the j-th cell. Further, n denotes a noise vector for Nᵣₓ×1 and satisfies Expression (2) below.

E{nn^{H}}=σ²I_{N}_{ᵣₓ} (2)

Further, A^{H} is a complex transposed matrix of A, whereas E{A} is an average of A's. When I_{Nrx} denotes a unit matrix of Nᵣₓ×Nᵣₓ, it is possible to express the demodulated signal resulting from a maximal ratio combining process, by using Expression (3) below.

$$z = {h}_{i , k , i}^{H} {y}_{i , k} = {‖ {h}_{i , k , i} ‖}^{2} {x}_{i} + {h}_{i , k , i}^{H} {\sum }_{j = 1 , j \neq i}^{N} {h}_{i , k , j} {x}_{j} + {h}_{i , k , i}^{H} n \qquad ( 3 )$$

Accordingly, when the transmission power level of each of the cells C1 to C7 is expressed by using Expression (4) below, it is possible to express the SNR after the demodulation by using Expression (5) below.

$$\begin{matrix}{P}_{j} = E \{ {\vert {X}_{j} \vert}^{2} \} & ( 4 ) \\ {γ}_{i , k} = \frac{\frac{{‖ {h}_{i , k , i} ‖}^{2}}{{σ}^{2}} {P}_{i}}{1 + \frac{1}{{σ}^{2} {‖ {h}_{i , k , i} ‖}^{2}} {\sum }_{j = 1 , j \neq i}^{N} {\vert {h}_{i , k , i}^{H} {h}_{i , k , j} \vert}^{2} {P}_{j}} & ( 5 )\end{matrix}$$

In this situation, it is possible to express the CSI value of the k-th user connected to the i-th cell by using Expressions (6) and (7) below. The CSI value is fed back to the base station 100.

$$\begin{matrix}{α}_{i , k , i} = \frac{{‖ {h}_{i , k , i} ‖}^{2}}{{σ}^{2}} & ( 6 ) \\ {α}_{i , k , j} = \frac{{\vert {h}_{i , k , i}^{H} {h}_{i , k , j} \vert}^{2}}{{σ}^{2} {‖ {h}_{i , k , i} ‖}^{2}} , \\ j = 1 , 2 , … , N , j \neq i & ( 7 )\end{matrix}$$

When it is possible to estimate the downlink channel from the uplink channel like when a Time Division Duplex (TDD) system is being used, the CSI value presented above may be calculated by the base station 100 itself, instead of being fed back from the wireless terminal 30 of the user or the like.

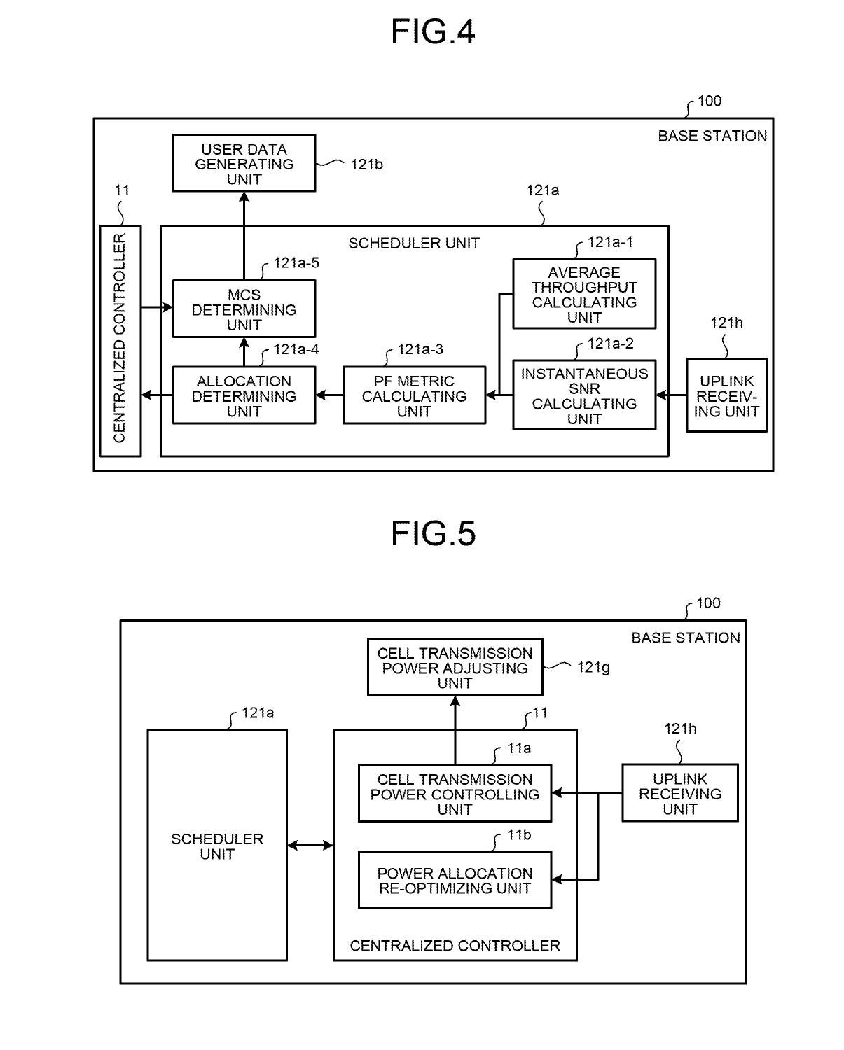

Next, configurations of the scheduler unit 121a and the centralized controller 11 included in the base station 100 will be explained more in detail, with reference to FIGS. 4 and 5.

FIG. 4 is a block diagram illustrating a functional configuration of the scheduler unit 121a included in the base station 100 according to the first embodiment. As illustrated in FIG. 4, the scheduler unit 121a includes an average throughput calculating unit 121a-1, an instantaneous SNR calculating unit 121a-2, a PF metric calculating unit 121a-3, an allocation determining unit 121a-4, and an MCS determining unit 121a-5. These constituent elements are connected to one another in such a manner that signals and data can be input and output either in one direction or in two directions.

The average throughput calculating unit 121a-1 calculates an average throughput of each of the users (the wireless terminals 30). The instantaneous SNR calculating unit 121a-2 included in the scheduler unit 121a of an i-th baseband unit 121 calculates an instantaneous SNR by using an initial transmission power level of each of the cells, with respect to the wireless terminals connected to the i-th cell, by using Expression (8) below.

Instantaneous SNR=γ_{i,k}(P₁⁽⁰⁾,P₂⁽⁰⁾, . . . ,P_{N}⁽⁰⁾ (8)

In this situation, it is assumed that Expression (9) below is true.

$${γ}_{i , k} ( {P}_{1} , {P}_{2} , … , {P}_{N} ) = \frac{{α}_{i , k , i} {P}_{i}}{1 + {\sum }_{j = 1 , j \neq i}^{N} {α}_{i , k , j} {P}_{j}} \qquad ( 9 )$$

Further, it is assumed possible to express the initial transmission power level of each of the cells by using Expression (10) below, for example.

P₁⁽⁰⁾=P₂⁽⁰⁾= . . . =P_{N}⁽⁰⁾=1 (10)

The PF metric calculating unit 121a-3 calculates a PF metric and power allocation among the users, for each of different combinations of users connected to the cells of its own, by using Expression (11) below.

$${max}_{{p}_{i , {S}_{i}}} {\sum }_{{k}^{′} ∈ {S}_{i}} \frac{{R}_{i , {k}^{′}} ( {S}_{i} , {p}_{i , {S}_{i}} )}{{T}_{i , {k}^{′}}} \qquad ( 11 )$$

In Expression (11), Sᵢ denotes a set of indexes k′ of the users contained in the combination of users. T_{i,k′} denotes an average throughput of a k′-th user connected to the i-th cell. Further, R_{i,k′}(Sᵢ,p_{i,si}) denotes an instantaneous throughput of the k′-th user connected to the i-th cell corresponding to the combination of users Sᵢ and the power allocation p_{i,si} among the users. Accordingly, it is possible to express R_{i,k′}(Sᵢ,pᵢ) by using Expression (12) below.

$${R}_{i , {k}^{′}} ( {S}_{i} , {p}_{i} ) = {log}_{2} ( 1 + \frac{{p}_{i , {k}^{′}} {γ}_{i , {k}^{′}}}{1 + {γ}_{i , {k}^{′}} {\sum }_{l ∈ {S}_{i} , l \neq {k}^{′} , {γ}_{i , j} > {γ}_{i , {k}^{′}}} {p}_{i , l}} ) \qquad ( 12 )$$

The allocation determining unit 121a-4 determines a combination of users expressed with Mathematical Formula 13 below that has the largest PF metric value, as the users subject to the scheduling process, by using Expression (13) below.

Ŝᵢ

$$( {\hat{S}}_{i} , {\hat{p}}_{i , {\hat{S}}_{i}} ) = arg {max}_{{S}_{i} ∈ {A}_{i} , {p}_{i , {S}_{i}}} {\sum }_{{k}^{′} ∈ {S}_{i}} \frac{{R}_{i , {k}^{′}} ( {S}_{i} , {p}_{i , {S}_{i}} )}{{T}_{i , {k}^{′}}} \qquad ( 13 )$$

In Expression (13), Aᵢ denotes a universal set of combinations obtained by selecting one to mₘₐₓ users from among the users connected to the i-th cell. Further, in Expression (13) above, Mathematical Formula 15 below denotes such power allocation among the users that maximizes the PF metric value for the combination of users expressed with Mathematical Formula 16 below.

\hat{p}_{i,ŝ}_{ᵢ}

Ŝᵢ

The allocation determining unit 121a-4 notifies the centralized controller 11 of the combination of users subject to the scheduling process calculated by using Expression (13) above, the CSI information of the users subject to the scheduling process, the instantaneous SNR, and the power allocation among the users.

FIG. 5 is a block diagram illustrating a functional configuration of the centralized controller 11 included in the base station 100 according to the first embodiment. As illustrated in FIG. 5, the centralized controller 11 includes a cell transmission power controlling unit 11a and a power allocation re-optimizing unit 11b among the users in a cell. These constituent elements are connected to one another in such a manner that signals and data can be input and output either in one direction or in two directions.

The cell transmission power controlling unit 11a first initializes the transmission power level of each of the cells by using Expression (14) below. Further, the cell transmission power controlling unit 11a initializes a variable t denoting the number of times of iterations so as to be equal to 1.

P⁽⁰⁾=[P₁⁽⁰⁾P₂⁽⁰⁾ . . . P_{N}⁽⁰⁾] (14)

By using Expression (15) below, the cell transmission power controlling unit 11a calculates a PF metric value of the users subject to the scheduling process determined for the i-th cell, at a t-th iteration.

$${f}_{i} ( {P}^{( t - 1 )} ) = {\sum }_{{k}^{′} ∈ {\hat{S}}_{i}} \frac{R ( {\hat{S}}_{i} , {γ}_{i , {k}^{′}} )}{{T}_{i , {k}^{′}}} \qquad ( 15 )$$

After that, the cell transmission power controlling unit 11a calculates a total sum of the calculated PF metric values corresponding to all the cells, by using Expression (16) below.

$$F ( {P}^{( t - 1 )} ) = {\sum }_{i = 1}^{N} {f}_{i} ( {P}^{( t - 1 )} ) \qquad ( 16 )$$

Further, by using the total sum F of the PF metric values corresponding to all the cells, the cell transmission power controlling unit 11a calculates a gradient vector of F with respect to the transmission power levels P₁, P₂, . . . and P_{N} of the cells, by using Expression (17) below. In Expression (17), a^{T} denotes the transposed vector of a vector a.

$$∇ F ( {P}^{( t - 1 )} ) = {[ \begin{matrix}\frac{\partial F ( {P}^{( t - 1 )} )}{\partial {P}_{1}} & \frac{\partial F ( {P}^{( t - 1 )} )}{\partial {P}_{2}} & … & \frac{\partial F ( {P}^{( t - 1 )} )}{\partial {P}_{N}}\end{matrix} ]}^{T} \qquad ( 17 )$$

Accordingly, the cell transmission power controlling unit 11a is able to calculate the gradient of F, by using Expression (18) below.

$$\frac{\partial F}{\partial {P}_{i}} = {\sum }_{i = 1}^{N} \frac{\partial {f}_{i}}{\partial {P}_{l}} \\ \frac{\partial {f}_{i}}{\partial {P}_{l}} = {\sum }_{{k}^{′} ∈ {\hat{S}}_{i}} \frac{1}{{T}_{i , {k}^{′ }}} \frac{\partial {R}_{i , {k}^{′}} ( {\hat{S}}_{i} , {\hat{p}}_{i , {\hat{S}}_{i}} )}{\partial {P}_{l}} \\ \frac{\partial {R}_{i , {k}^{′}} ( {\hat{S}}_{i} , {\hat{p}}_{i , {\hat{S}}_{i}} )}{\partial {P}_{l }} = \frac{{p}_{i , {k}^{′}}}{1 + \frac{{p}_{i , {k}^{′ }} {γ}_{i , {k}^{′}}}{1 + {γ}_{i , {k}^{′}} {\sum }_{l ∈ {S}_{i} , l \neq {k}^{′} , {γ}_{i , l} > {γ}_{i , {k}^{′}}} {p}_{i , l}}} \frac{\partial }{\partial {P}_{l}} ( \frac{{γ}_{i , {k}^{′}}}{1 + {γ}_{i , {k}^{′}} {\sum }_{l ∈ {S}_{i} , l \neq {k}^{′} , {γ}_{i , l} > {γ}_{i , {k}^{′}}} {p}_{i , l}} ) \\ \frac{\partial }{\partial {P}_{l}} ( \frac{{γ}_{i , {k}^{′}}}{1 + {γ}_{i , {k}^{′}} {\sum }_{l ∈ {S}_{i} , l \neq {k}^{′} , {γ}_{i , l} > {γ}_{i , {k}^{′}}} {p}_{i , l}} ) = \frac{1}{{( 1 + {γ}_{i , {k}^{′}} {\sum }_{l ∈ {S}_{i} , l \neq {k}^{′} , {γ}_{i , j} > {γ}_{i , {k}^{′}}} {p}_{i , l} )}^{2}} \frac{\partial {γ}_{i , {k}^{′}}}{\partial {P}_{l}} \qquad ( 18 )$$

In Expression (18), when l=i is satisfied, Expression (19) below is true. On the contrary, when l≠i is satisfied, Expression (20) below is true.

$$\begin{matrix}\frac{\partial {γ}_{i , {k}^{′ }} ( {P}_{1} , {P}_{2} , … , {P}_{N} )}{\partial {P}_{l}} = \frac{{α}_{i , k , i}}{1 + {{\sum }_{j = 1 , j \neq i}}^{N} {α}_{i , k , j} {P}_{j}} = \frac{{γ}_{i , {k}^{′}} ( {P}_{1} , {P}_{2} , … , {P}_{N} )}{{P}_{i}} & ( 19 ) \\ \frac{\partial {γ}_{i , {k}^{′}} ( {P}_{1} , {P}_{2} , … , {P}_{N} )}{\partial {P}_{1}} = - {\{ {γ}_{i , {k}_{i , {k}^{′}}^{′}} ( {P}_{1} , {P}_{2} , … , {P}_{N} ) \}}^{2} \frac{{α}_{i , k , l}}{{α}_{i , k , i} {P}_{i}} & ( 20 )\end{matrix}$$

Subsequently, by using Expression (21) below, the cell transmission power controlling unit 11a determines such an vertex of which the inner product with the gradient vector is the largest from among the vertices in an feasible region, to be an updating direction. In Expression (21), P_{i,min} and P_{i,max} denote the minimum cell transmission power level and the maximum cell transmission power level with respect to the i-th cell transmission power level, respectively.

d^{(t)}=arg max(∇F(P^{(t-1)}))^{T}P subject to P_{i,min}≦Pᵢ≦P_{i,max} (21)

After that, the cell transmission power controlling unit 11a determines an updating step indicating the amount by which an advance is made in the updating direction, by using Expression (22) below.

P^{(t)}=(1−β^{λ})P^{(t-1)}+β^{λ}d (22)

In Expression (22), λ denotes the smallest integer that satisfies Expression (23) below. Further, α and β are set values that are determined in advance.

F((1−β^{λ})P^{(t-1)}+β^{λ}d)−F(P^{(t-1)})≧αβ^{λ}(∇F)^{T}d (23)

Subsequently, the cell transmission power controlling unit 11a performs a convergence test by using Expression (24) below. In Expression (24), ε is a set value determined in advance.

∥P^{(t+1)}−P^{(t)}∥²<ε (24)

In other words, when Expression (24) above is satisfied, the cell transmission power controlling unit 11a ends the iteration process above and notifies the scheduler unit 121a and the cell transmission power adjusting unit 121g of the value P^{(t)} from Expression (22) above as a determined transmission power value. On the contrary, when Expression (24) above is not satisfied, the cell transmission power controlling unit 11a increments the variable t by 1, and if the variable t is smaller than or equal to a predetermined constant τ, the cell transmission power controlling unit 11a performs the gradient vector calculating process again by using Expression (17) above.

By using the cell transmission power level determined by the cell transmission power controlling unit 11a and Expressions (9) and (11) above, the power allocation re-optimizing unit 11b optimizes again the power allocation among the users subject to the scheduling process in the cell, in such a manner that the total sum of PF metric values becomes the largest. Further, the power allocation re-optimizing unit 11b notifies the MCS determining unit 121a-5 included in the scheduler unit 121a of the re-optimized power allocation and the instantaneous throughput. The MCS determining unit 121a-5 determines the MCS value of the wireless terminal 30 of each of the users, based on the instantaneous throughput indicated in the notification from the power allocation re-optimizing unit 11b.

Next, a hardware configuration will be explained.

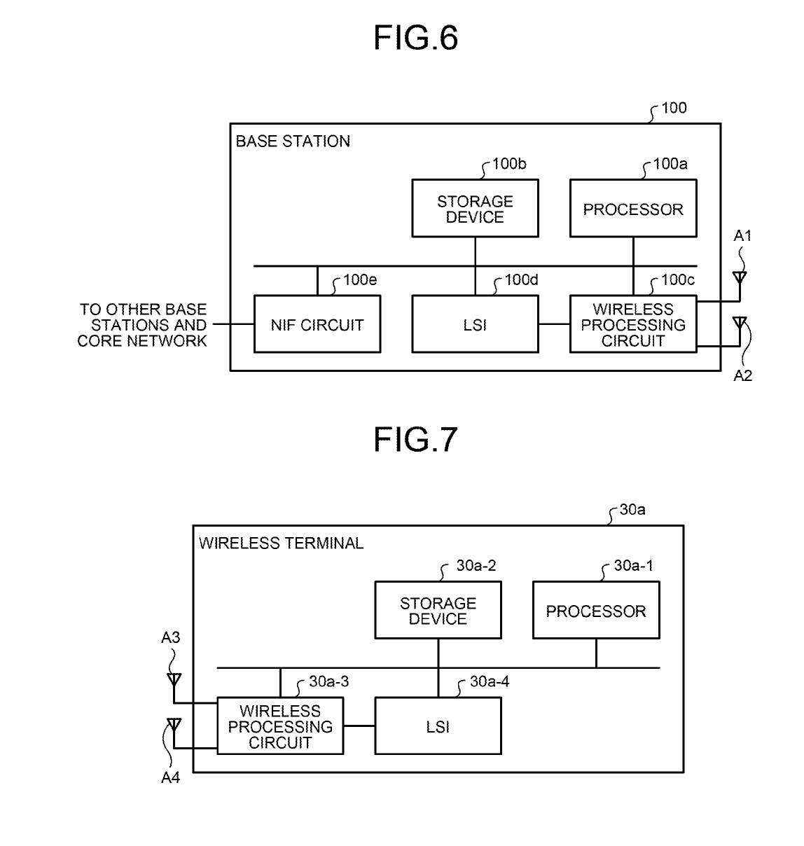

FIG. 6 is a block diagram illustrating a hardware configuration of the base station 100. As illustrated in FIG. 6, the base station 100 includes a processor 100a, a storage device 100b, a wireless processing circuit 100c, a Large Scale Integration (LSI) 100d, and a Network InterFace (NIF) circuit 100e. The wireless processing circuit 100c includes antennas A1 and A2. The centralized controller 11 and the baseband units 121 to 127 included in the concentration controlling station 10 are realized by the processor 100a configured with, for example, a Central Processing Unit (CPU), a Digital Signal Processor (DSP), or the like. The RRHs 20a to 20g are realized by the wireless processing circuit 100c, for example. The storage device 100b is configured with, for example, a Random Access Memory (RAM), a Read-Only Memory (ROM), a flash memory, or the like and is configured to store therein the user data and the control signals, as well as various types of values such as the power level and the Modulation and Coding Scheme (MCS) value of each of the wireless terminals, and the like.

FIG. 7 is a block diagram illustrating a hardware configuration of the wireless terminal 30a. As illustrated in FIG. 7, the wireless terminal 30a includes a processor 30a-1, a storage device 30a-2, a wireless processing circuit 30a-3, and an LSI 30a-4. The wireless processing circuit 30a-3 includes antennas A3 and A4. The CP removing unit 32, the FFT unit 33, the channel demapping unit 34, the CSI estimating unit 35, the downlink control signal demodulating and decoding unit 36, the user data demodulating unit 37, and the Ack/Nack generating unit 38 are realized by, for example, the processor 30a-1 configured with a CPU, a DSP, or the like. Further, the downlink wireless processing unit 31, the uplink transmitting unit 39, the uplink wireless processing unit 310 are realized by, for example, the wireless processing circuit 30a-3. Further, the storage device 30a-2 may be configured with, for example, a RAM, a ROM, a flash memory, or the like and is configured to store therein the user data and the control signals, as well as various types of values such as the power level, the MCS value, and the CSI value of each of the wireless terminals, and the like.

The configuration of the wireless terminal 30a has thus been explained as an example. Configurations of the other wireless terminals 30b to 30q illustrated in FIG. 1 are the same as the configuration of the wireless terminal 30a. Accordingly, the constituent elements that are the same as one another will be referred to by using the reference characters having the same endings, and illustrations with drawings and detailed explanations thereof will be omitted.

Next, an operation of the wireless communication system 1 according to the first embodiment will be explained.

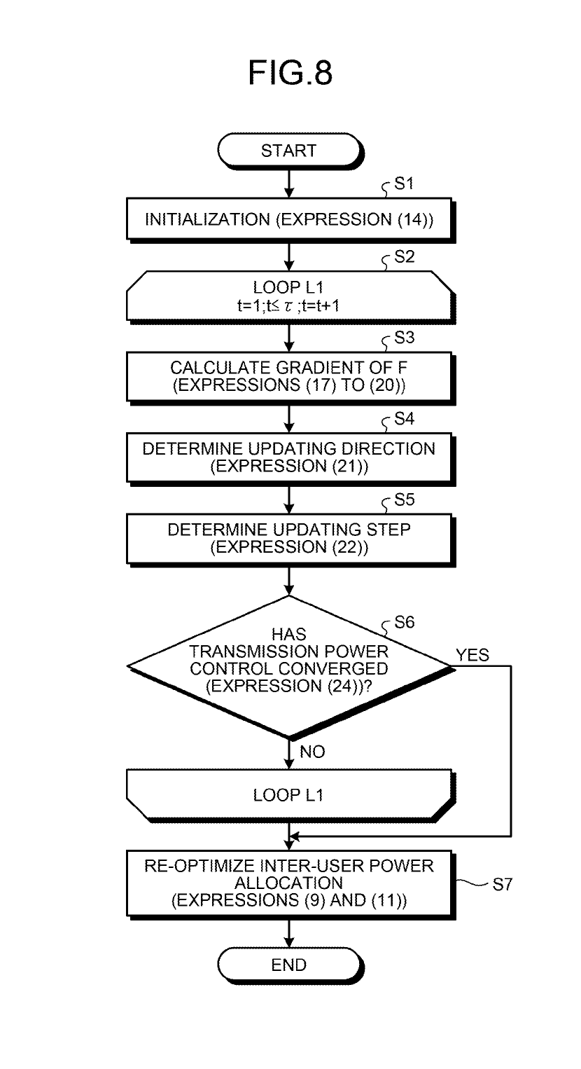

FIG. 8 is a flowchart for explaining the inter-user power allocation re-optimizing process performed by the centralized controller 11 included in the base station 100 according to the first embodiment. First, the cell transmission power controlling unit 11a included in the centralized controller 11 initializes the transmission power level of each of the cells by using Expression (14) above (step S1). After that, the cell transmission power controlling unit 11a sets the initial value “1” as the variable t used for counting the number of times of iterations and executes a loop L1 for the first time (step S2).

Subsequently, the cell transmission power controlling unit 11a calculates the gradient vector of F, by using Expressions (17) to (20) above (step S3). After that, by using Expression (21) above, the cell transmission power controlling unit 11a determines such an vertex of which the inner product with the gradient vector is the largest from among the vertices in the feasible region, to be an updating direction (step S4). Subsequently, by using Expression (22) above, the cell transmission power controlling unit 11a determines an updating step indicating the amount by which an advance is made in the updating direction determined at step S4 (step S5).

After that, by using Expression (24) above, the cell transmission power controlling unit 11a judges whether the transmission power control exercised on the cells C1 to C7 structuring the wireless communication system 1 has converged or not (step S6). When the judgment result indicates that the transmission power control has converged (step S6: Yes), the centralized controller 11 exits the loop L1. Further, by using the cell transmission power level P determined by the cell transmission power controlling unit 11a and Expressions (9) and (11) above, the power allocation re-optimizing unit 11b determines the power allocation among the plurality of wireless terminals 30a to 30q, for each of the cells C1 to C7 in such a manner that the total sum of the PF metric values becomes the largest. As a result, the inter-user power allocation in each of the cells C1 to C7 has been re-optimized (step S7).

On the contrary, when the transmission power control has not converged at step S6 above (step S6: No), the cell transmission power controlling unit 11a included in the centralized controller 11 performs the process at step S2 again, so as to increment the current value of the variable t by 1. After that, if the value of the variable t is equal to or smaller than the predetermined constant τ, the cell transmission power controlling unit 11a performs the series of processes at steps S3 through S6 above (the loop L1) again. On the contrary, if the value of the variable t is larger than the constant τ, the cell transmission power controlling unit 11a exits the series of processes at steps S3 through S6 (the loop L1) and further performs the process at step S7.

As explained above, the wireless communication system 1 according to the first embodiment includes the base station 100 and the plurality of wireless terminals 30 that capable of wirelessly communicating with the base station 100. The base station 100 includes the plurality of RRHs 20a to 20g and the cell transmission power controlling unit 11a. The plurality of RRHs 20a to 20g form the plurality of cells C1 to C7. The cell transmission power controlling unit 11a determines the transmission power level for each of the cells C1 to C7, in such a manner that the value obtained by totaling the indexes (e.g., the PF metric values in Expression (15)) becomes the largest, the indexes each indicating the degree of fairness in communication opportunities (e.g., reception opportunities) among the wireless terminals 30 in a corresponding one of the plurality of cells C1 to C7. Each of the plurality of wireless terminals 30 includes the downlink wireless processing unit 31. In the cell (e.g., the cell C1) in which the wireless terminals 30 are present, the downlink wireless processing unit 31 receives a signal from each of the plurality of RRHs 20a to 20g, by using the transmission power level of the cell (e.g., the cell C1) determined by the cell transmission power controlling unit 11a.

In other words, the base station 100 included in the wireless communication system 1 controls the transmission power level of each of the cells in such a manner that the total sum of the PF metric values (the total of the PF metric values of the cells C1 to C7) becomes the largest, the total sum being calculated by totaling, with respect to the plurality of cells, the PF metric value of the users subject to the scheduling process in each of the cells. With this arrangement, it is possible to control the inter-cell power suitable for the NOMA method. It is therefore possible to enhance the degree of fairness in the communication opportunities among the wireless terminals in the plurality of cells. As a result, it is possible to enhance the degree of evenness of the communication service in a service area structured with the plurality of cells.

Further, in the wireless communication system 1, the base station 100 may further include the power allocation re-optimizing unit 11b that determines the allocation among the plurality of NOMA multiplex wireless terminals 30 that are present in each of the cells C1 to C7, with respect to the transmission power level determined by the cell transmission power controlling unit 11a for each of the cells C1 to C7. With this arrangement, it is possible to control the transmission power with a higher level of precision while taking into consideration not only the power allocation among the plurality of cells, but also the power allocation among the plurality of users (the wireless terminals 30) in each of the cells.

### First Modification Example

Next, a first modification example will be explained. In the first embodiment above, the example is explained in which, after the cell transmission power controlling unit 11a has completed the transmission power control for each of the cells, the power allocation re-optimizing unit 11b optimizes the transmission power allocation among the users in each of the cells. However, the present disclosure is not limited to this example. For instance, the centralized controller 11 included in the base station 100 may alternately execute the process of calculating the transmission power level for each of the cells and the process of allocating the transmission power among the users in each of the cells. For example, by setting the value of the variable t on two levels (t₁ and t₂), the centralized controller 11 included in the base station 100 may alternately execute the process of calculating the transmission power level for each of the cells and the process of allocating the transmission power among the users in each of the cells for each of the values of t₁ and t₂.

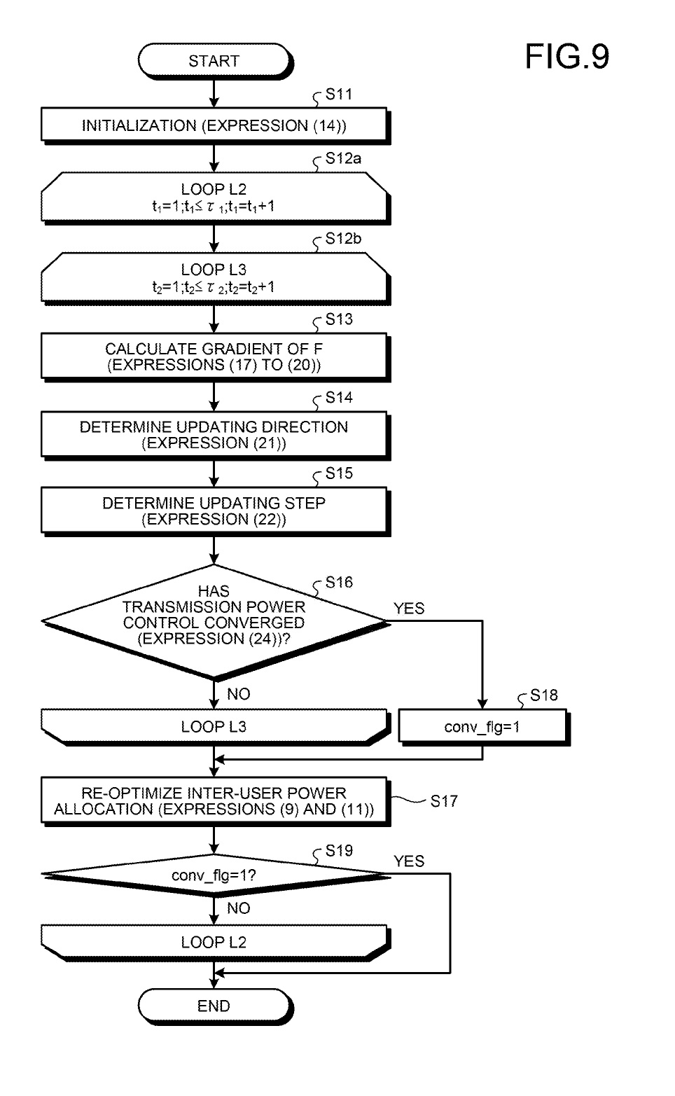

Next, an operation of the centralized controller 11 according to the first modification example will be explained while focusing on the differences from the first embodiment. FIG. 9 is a flowchart for explaining an inter-user power allocation re-optimizing process performed by the centralized controller 11 included in the base station 100 according to the first modification example. Because FIG. 9 contains multiple processes that are the same as those in FIG. 8 referenced in the explanation of the operation according to the first embodiment, the same steps will be referred to by using the reference characters having the same endings, and detailed explanation thereof will be omitted. More specifically, the processes at steps S11 through S17 in FIG. 9 correspond to the processes at steps S1 through S7 in FIG. 8.

As illustrated in FIG. 9, the centralized controller 11 uses t at two levels (t₁ and t₂) for two loops L2 and L3. By using this arrangement, the centralized controller 11 alternately executes the cell transmission power controlling process implemented by the cell transmission power controlling unit 11a and the intra-cell inter-user power allocation re-optimizing process implemented by the power allocation re-optimizing unit 11b. In other words, when the loop L3 (steps S13 through S16) started at step S12b has completed, the centralized controller 11 performs the process of re-optimizing the inter-user power allocation in each of the cells C1 to C7 (step S17). At step S16, when the transmission power control has converged (step S16: Yes), the centralized controller 11 sets a variable conv_flg to 1 (step S18). After that, the centralized controller 11 judges whether the variable conv_flg is 1 or not (step S19). When the variable conv_flg is 1 (step S19: Yes), the centralized controller 11 ends the process. On the contrary, when the variable conv_flg is not 1 (step S19: No), the centralized controller 11 returns to the process at step S12a.

As explained above, the base station 100 included in the wireless communication system 1 according to the first modification example alternately executes the process of determining the transmission power level for each of the cells C1 to C7 (steps S3 through S6 in FIG. 8) and the process of determining the allocation among the NOMA multiplex wireless terminals 30 in the plurality of cells (step S7 in FIG. 8). By using the wireless communication system 1 according to the first modification example, it is possible to exercise the transmission power control and to re-optimize the power allocation flexibly and accurately, in accordance with changes in the quantity and the positions of the wireless terminals over the course of time. As a result, it is possible to enhance adaptability to the communication environment of the wireless communication system 1.

### Second Modification Example

Next, a second modification example will be explained. In the first embodiment above, the example is explained in which the CSI estimating unit 35 included in the wireless terminal 30 feeds back the CSI value to the base station 100, while taking into account the instantaneous channel as ab interference amount from the interfering cells, as indicated in Expression (7) above. In contrast, the CSI estimating unit 35 included in the wireless terminal 30 according to the second modification example feeds back a value approximated by an average interference amount to the base station 100, instead of the CSI value itself.

For example, the CSI estimating unit 35 is able to use Expression (25) below for calculating the abovementioned approximated value.

$${γ}_{i , k} = \frac{\frac{{‖ {h}_{i , k , i} ‖}^{2}}{{σ}^{2}} {P}_{i}}{1 + \frac{1}{{σ}^{2}} {\sum }_{j = 1 , j \neq i}^{N} {RSRP}_{i , k , j} {P}_{j}} \qquad ( 25 )$$

In Expression (25), RSRP (Reference Signal Received Power)_{i,k,j} denotes an average reception power level from the j-th cell for the k-th user (wireless terminal) connected to the i-th cell.

The CSI estimating unit 35 feeds back the value α_{i,k,i} in Expression (6) above and the value α_{i,k,j} in Expression (26) below to the base station 100. It is noted, however, that the feedback cycle of the value α_{i,k,j} is longer than the feedback cycle of the value α_{i,k,i}, and one cycle in an upper layer is as long as hundreds of milliseconds.

$${α}_{i , k , j} = \frac{{RSRP}_{i , k , j}}{{σ}^{2}} , j = 1 , 2 , … , N , j \neq i \qquad ( 26 )$$

As explained above, after the downlink signal is received, the CSI estimating unit 35 included in the wireless terminal 30 according to the second modification example feeds back the channel quality information to the base station 100, the channel quality information being approximated by the average interference amount from the cells other than the cell in which the wireless terminal 30 is present. The downlink signal may be, for example, a data signal or a pilot signal. The channel quality information may be the CSI value, for example. In the wireless communication system 1 according to the second modification example, the approximated value is used as the CSI value fed back from the wireless terminal 30 to the base station 100. With this arrangement, it is possible to efficiently use the wireless resources by reducing the amount of data fed back from the wireless terminals 30. Further, because the processing amount of the base station 100 is also reduced, it is possible to reduce the processing load of the base station 100.

### [b] Second Embodiment

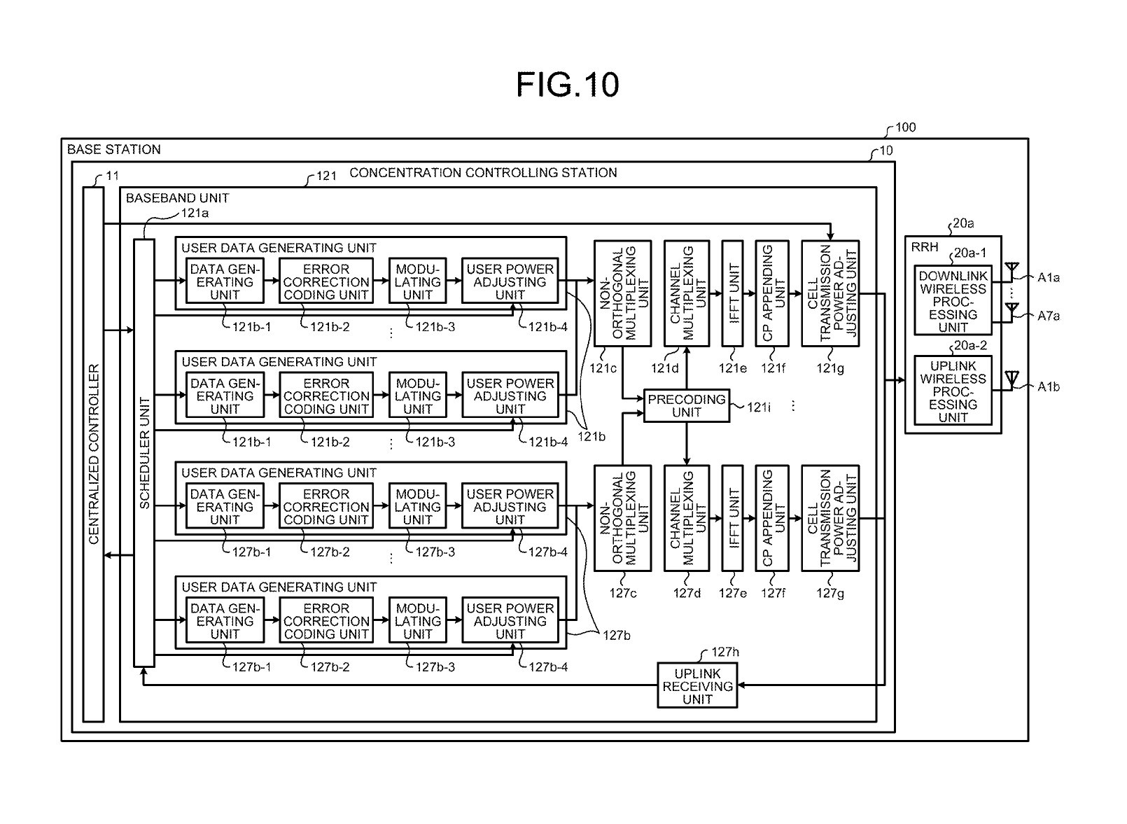

Next, a second embodiment will be explained. The wireless communication system 1 according to the second embodiment is applicable to a Multiple-Input and Multiple-Output (MIMO) method. FIG. 10 is a block diagram illustrating a functional configuration of the base station 100 according to the second embodiment. As illustrated in FIG. 10, the base station 100 according to the second embodiment has almost the same configuration as that of the base station 100 according to the first embodiment illustrated in FIG. 2, except that a precoding unit 121i is further included therein. Accordingly, some of the constituent elements of the second embodiment that are the same as those in the first embodiment will be referred to by using the same reference characters, and detailed explanation thereof will be omitted. In the following sections, the second embodiment will be explained while focusing on the differences from the first embodiment. The precoding unit 121i included in the base station 100 forms beams by multiplying the signal resulting from the non-orthogonal multiplexing by a precoding matrix and performs a non-orthogonal multiplexing process for each of the beams.

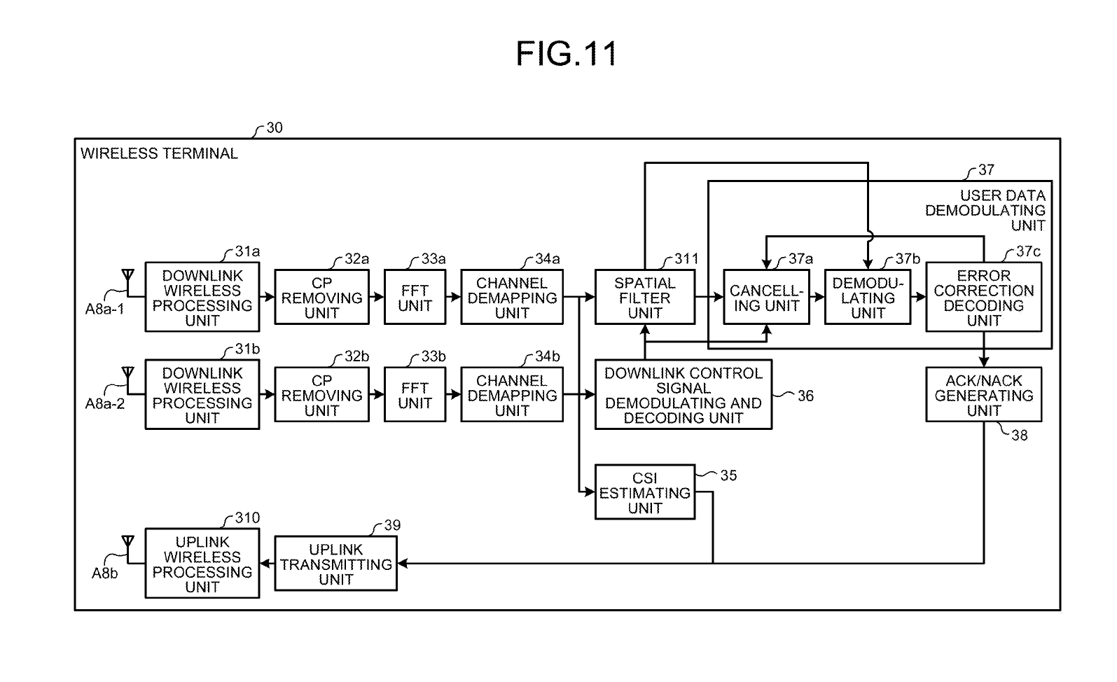

FIG. 11 is a block diagram illustrating a functional configuration of a wireless terminal 30 according to the second embodiment. As illustrated in FIG. 11, the wireless terminal 30 according to the second embodiment has almost the same configuration as that of the wireless terminal 30 according to the first embodiment illustrated in FIG. 3, except that a spatial filter unit 311 is further included therein. Accordingly, some of the constituent elements of the second embodiment that are the same as those in the first embodiment will be referred to by using the same reference characters, and detailed explanation thereof will be omitted. In the following sections, the second embodiment will be explained while focusing on the differences from the first embodiment.

The downlink control signal demodulating and decoding unit 36 demodulates and decodes the received control signal and obtains the precoding matrix that was actually applied and is contained in the control signal, as well as information for each of the beams about the MCS values and the power levels of the wireless terminals 30 in the beam. In this situation, when a wireless-terminal-specific pilot is used, it is unnecessary for the base station 100 to notify the wireless terminals 30 of the precoding matrix as a control signal. Further, the obtained information may be only the information in the beam in which the wireless terminal 30 of its own is included.

The spatial filter unit 311 separates the beams by using, for example, a Minimum Mean Square Error (MMSE) method. The user data demodulating unit 37 performs an error correcting process when, with respect to a beam containing a data signal addressed to the wireless terminal 30 of its own, a wireless terminal having a smaller MCS value than the MCS value of the wireless terminal 30 of its own is non-orthogonally multiplexed in the beam. More specifically, the user data demodulating unit 37 performs an error correcting process by employing the error correction decoding unit 37c, in ascending order of MCS values, starting with a non-orthogonal multiplex wireless terminal having the smallest MCS value. Further, the user data demodulating unit 37 performs a process of cancelling the non-orthogonally multiplexed user data from the reception signal, by employing the cancelling unit 37a. After that, the user data demodulating unit 37 finally performs an error correcting process on the data signal addressed to the wireless terminal 30 of its own. The uplink transmitting unit 39 performs an error correction coding process and a modulating process on the uplink user data, the Ack/Nack signal, desired precoding matrix information, and a CSI value corresponding to each of the beams when the desired precoding is applied.

Next, a process performed by the CSI estimating unit 35 will be explained. When the number of transmission antennas for the cells C1 to C7 is expressed as Nₜₓ, it is possible to express a reception signal of the k-th user (wireless terminal) connected to the i-th cell, by using Expression (27) below.

$${y}_{i , k} = {\sum }_{b = 1}^{B} {H}_{i , k , i} {v}_{i , b} {x}_{i , b} + n \qquad ( 27 )$$

In Expression (27), y_{i,k} denotes a reception signal vector for Nᵣₓ×1. Further, H_{i,k,i} denotes the channel matrix for Nᵣₓ×Nₜₓ between the k-th user connected to the i-th cell and the i-th cell. Also, v_{i,b} denotes a precoding vector for Nₜₓ×1 with respect to a b-th beam of the i-th cell. In Expression (27), B denotes the total number of beams. Further, x_{i,b} denotes a transmission signal of the b-th beam in the i-th cell. Also, n denotes an interference noise vector for Nᵣₓ×1.

In this situation, when a spatial filter weight vector for 1×Nᵣₓ with respect to a b′-th beam is expressed as indicated in Mathematical Formula 31 below, it is possible to express the demodulated signal by using Expression (28) below.

$${w}_{i , {b}^{′} , k}^{H} \\ {z}_{i , {b}^{′}} = {w}_{i , {b}^{′} , k}^{H} {y}_{i , k} = {w}_{i , {b}^{′} , k}^{H} {\sum }_{b = 1}^{B} {H}_{i , k , i} {v}_{i , b} {x}_{i , b} + {w}_{i , {b}^{′} , k}^{H} n \qquad ( 28 )$$

Accordingly, it is possible to express the post-processing SNR by using Expression (29) below.

$${γ}_{i , {b}^{′} , k} = \frac{{\vert {w}_{i , {b}^{′} , k}^{H} {H}_{i , k , i} {v}_{i , {b}^{′}} \vert}^{2} {P}_{i , {b}^{′}}}{{\sum }_{b = 1 , b \neq {b}^{′}}^{B} {\vert {w}_{i , {b}^{′} , k}^{H} {H}_{i , k , i} {v}_{i , b} \vert}^{2} {P}_{i , b} + {σ}^{2} {‖ {w}_{i , {b}^{′} , k} ‖}^{2}} \qquad ( 29 )$$

In Expression (29), P_{i,b} denotes the power level of the b-th beam in the i-th cell and satisfies Expression (30) below.

$${\sum }_{b = 1}^{B} {P}_{i , b} = {P}_{i} \qquad ( 30 )$$

In this situation, with respect to the beams or a desired beam, the wireless terminal 30 feeds back a value calculated by using Expressions (31) and (32) below to the base station 100 as CSI information.

$$\begin{matrix}{α}_{i , {b}^{′} , k}^{( 1 )} = \frac{{\vert {w}_{i , {b}^{′} , k}^{H} {H}_{i , k , i} {v}_{i , {b}^{′}} \vert}^{2}}{{‖ {w}_{i , {b}^{′} , k} ‖}^{2}} & ( 31 ) \\ {α}_{i , {b}^{′} , k}^{( 2 )} = \frac{{{\sum }_{b = 1 , b \neq {b}^{′}}}^{B} {\vert {w}_{i , {b}^{′} , k}^{H} {H}_{i , k , i} {v}_{i , b} \vert}^{2}}{{‖ {w}_{i , {b}^{′} , k} ‖}^{2}} & ( 32 )\end{matrix}$$

Further, the wireless terminal 30 may feed back a Reference Signal Received Power (RSRP) value for the cells C1 to C7 to the base station 100, by using a relatively longer cycle (e.g., a cycle of approximately hundreds of milliseconds in an upper layer).

With respect to the beams of the cells C1 to C7 belonging to the base station 100, the PF metric calculating unit 121a-3 included in the base station 100 calculates a PF metric value and the inter-user power allocation for each of the combinations of wireless terminals 30 connected to the cells C1 to C7 of its own, by using Expression (33) below.

$${max}_{{p}_{i , b , {S}_{i}}} {\sum }_{{k}^{′} ∈ {S}_{i}} \frac{{R}_{i , b , {k}^{′}} ( {S}_{i} , {p}_{i , b , {S}_{i}} )}{{T}_{i , {k}^{′}}} \qquad ( 33 )$$

In Expression (33), the part indicated in Mathematical Formula 38 below denotes an instantaneous throughput corresponding to the b-th beam of the k′-th wireless terminal connected to the i-th cell, the combination of users Si, and the power allocation among the wireless terminals 30 expressed with Mathematical Formula 39 below, and it is possible to express the instantaneous throughput by using Expression (34) below.

$${R}_{i , b , {k}^{′}} ( {S}_{{i}^{′}} {p}_{i , b , {s}_{i}} ) \\ {p}_{i , b , {s}_{i}} \\ {R}_{i , b , {k}^{′}} ( {S}_{i} , {p}_{i , b} ) = {log}_{2} ( 1 + \frac{{p}_{i , b , {k}^{′}} {γ}_{i , b , {k}^{′}}}{1 + {γ}_{i , b , {k}^{′}} {\sum }_{l ∈ S , l \neq {k}^{′} , {γ}_{i , b , l} > {γ}_{i , b , {k}^{′}}} {p}_{i , b , l}} ) \qquad ( 34 )$$

The allocation determining unit 121a-4 included in the base station 100 determines the combination of the users that makes the PF metric value largest for each of the beams of the cells C1 to C7 of its own, to be the users subject to the scheduling process, by using Expression (35) below.

$$( {\hat{S}}_{i , b} , {\hat{p}}_{i , {\hat{S}}_{i , b}} ) = arg {max}_{{S}_{i} ∈ {A}_{i} , {p}_{i , {S}_{i }}} {\sum }_{{k}^{′} ∈ {S}_{i}} \frac{{R}_{i , b , {k}^{′}} ( {S}_{i} , {p}_{i , {S}_{i}} )}{{T}_{i , {k}^{′}}} \qquad ( 35 )$$

In this situation, it is possible to express the sum of the PF metric values for the beams of each of the cells C1 to C7 by using Expression (36) below.

$${f}_{i} ( {P}^{( t - 1 )} ) = {\sum }_{b = 1}^{B} {\sum }_{{k}^{′} ∈ {\hat{S}}_{i , b}} \frac{R ( {\hat{S}}_{i , b} , {γ}_{i , b , {k}^{′}} )}{{T}_{i , {k}^{′ }}} \qquad ( 36 )$$

Accordingly, it is possible to express the total sum of the RF metric values of all the cells C1 to C7 by using Expression (37) below.

$$F ( {P}^{( t - 1 )} ) = {\sum }_{i = 1}^{N} {f}_{i} ( {P}^{( t - 1 )} ) \qquad ( 37 )$$

As explained above, the plurality of RRHs 20a to 20g of the base station 100 included in the wireless communication system 1 according to the second embodiment transmit and receive signals by using the MIMO method to and from the plurality of wireless terminals 30. In this situation, in the same manner as in the first embodiment, the centralized controller 11 included in the base station 100 controls the transmission power levels of the cells C1 to C7 in such a manner that the value calculated from Expression (37) above becomes the largest. With this arrangement, the wireless communication system 1 according to the second embodiment is able to apply the technique for controlling the inter-cell power levels suitable for the NOMA method, also to the wireless terminals and the base station having the MIMO function.

### [c] Third Embodiment

Next, a third embodiment will be explained. In the first and the second embodiments above, the examples are explained with the dynamic cell transmission power controlling methods by which the cell transmission power levels are controlled for each of the instantaneous scheduling processes. In contrast, the wireless communication system 1 according to the third embodiment performs a semi-static cell transmission power controlling process of which the control cycle is longer. In the third embodiment, illustrations using drawings and detailed explanations of some of the constituent elements that are the same as those in the first embodiment will be omitted. The third embodiment will be explained below, while focusing on the differences from the first embodiment.

As a premise of the explanation, in the third embodiment, it is assumed that a non-orthogonal multiplexing process is performed on two users at maximum, and a predicted average throughput of the k-th user (wireless terminal) connected to the i-th cell is expressed as T_{i,k} indicated in Expression (38) below.

$${T}_{i , k} = {ρ}_{i , k} {R}_{i , k} + {\sum }_{l = k + 1}^{{K}_{i}} {ρ}_{i , k , l} {R}_{i , k , l} + {\sum }_{l = 1}^{k - 1} {ρ}_{i , l , k} {R}_{i , k , l} \qquad ( 38 )$$

In Expression (38), Kᵢ denotes the total quantity of wireless terminals 30 connected to the i-th cell. Further, ρ_{i,k} denotes a resource allocation ratio indicating the ratio of the k-th wireless terminal 30 having resources allocated thereto without non-orthogonal multiplexing. Further, ρ_{i,k,l} denotes a resource allocation ratio indicating the ratio of the k-th wireless terminal 30 and the l-th wireless terminal 30 having resources allocated thereto with non-orthogonal multiplexing. It is noted that the values Kᵢ, ρ_{i,k} and ρ_{i,k,l} satisfy a resource constraint condition expressed by Expression (39) below.

$${\sum }_{k = 1}^{{K}_{i}} ( {ρ}_{i , k} + {\sum }_{l = k + 1}^{{K}_{i}} {ρ}_{i , k , l} ) = 1 , {ρ}_{i , k} \geq 0 , {ρ}_{i , k , l} \geq 0 \qquad ( 39 )$$

Further, R_{i,k} denotes a predicted average throughput corresponding to when the k-th wireless terminal has all the resources allocated thereto without non-orthogonal multiplexing, and it is possible to express R_{i,k} by using Expression (40) below.

R_{i,k}=log(1+Γ_{i,k}) (40)

In Expression (40), Γ_{i,k} denotes an average SNR of the k-th wireless terminal connected to the i-th cell. It is possible to express Γ_{i,k} by using Expression (41) below. In Expression (41), RSRP_{i,k,j} denotes an average reception power level from the j-th cell with respect to the k-th wireless terminal connected to the i-th cell.

$${Γ}_{i , k} = \frac{{RSRP}_{i , k , i} {P}_{i}}{{N}_{0} + {{\sum }_{j = 1 , j \neq i}}^{N} {RSRP}_{i , k , j} {P}_{j}} \qquad ( 41 )$$

Further, R_{i,k,l} denotes a predicted average throughput of the k-th wireless terminal corresponding to when non-orthogonal multiplexing is applied to the k-th wireless terminal and the l-th wireless terminal so as to allocate all the resources thereto. It is possible to express R_{i,k,l} by using Expression (42) below, depending on which is larger between k and l. It is assumed that the relationship indicated in Expression (43) is satisfied.

$$\begin{matrix}{R}_{i , k , l} = log ( 1 + {p}_{i , k , l} {Γ}_{i , k} ) , when k < l \\ {R}_{i , k , l} = log ( 1 + \frac{( 1 - {p}_{i , k , l} ) {Γ}_{i , k}}{1 + {p}_{i , k , l} {Γ}_{i , k}} ) , when k > l & ( 42 ) \\ {Γ}_{i , 1} > {Γ}_{i , 2} > … > {Γ}_{i , {K}_{i }} & ( 43 )\end{matrix}$$

It is possible to express a PF utility value uᵢ of the wireless terminals 30 connected to the i-th cell by using Expression (44) below.

$${u}_{i} = {\sum }_{k = 1}^{{K}_{i}} log {T}_{i , k} \qquad ( 44 )$$

Further, it is possible to express the PF utility value U of all the cells by using Expression (45) below.

$$U = {\sum }_{i = 1}^{N} {u}_{i} \qquad ( 45 )$$

The wireless communication system 1 according to the third embodiment repeatedly performs an inter-user power allocation optimizing process, a resource allocation ratio optimizing process, and a cell transmission power optimizing process as described below, by using Expressions (38) to (45) above.

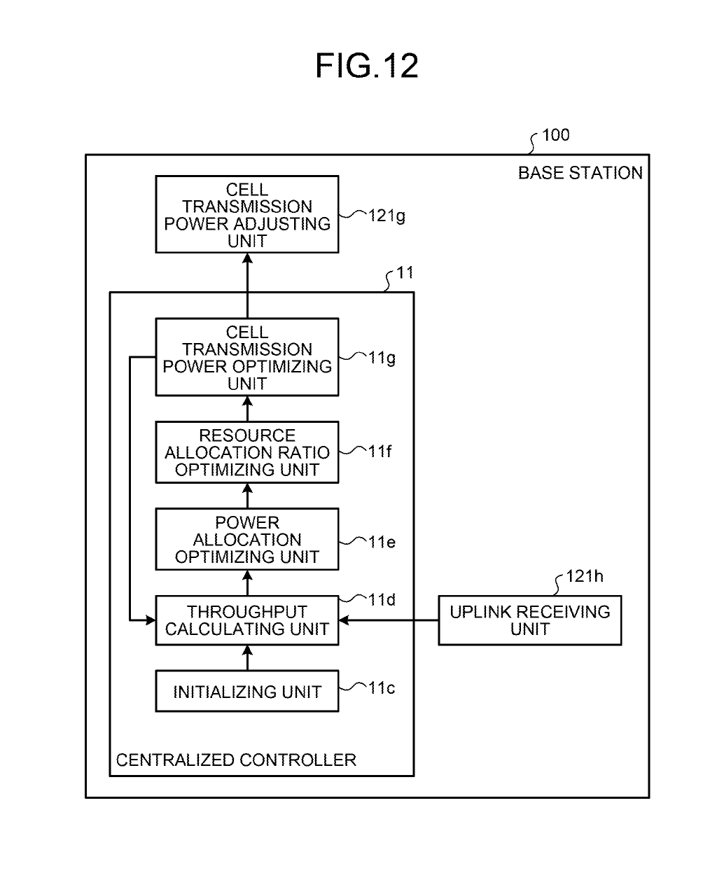

FIG. 12 is a block diagram illustrating a functional configuration of the centralized controller 11 included in the base station 100 according to the third embodiment. As illustrated in FIG. 12, the centralized controller 11 includes an initializing unit 11c, a throughput calculating unit 11d, a power allocation optimizing unit 11e, a resource allocation ratio optimizing unit 11f, and a cell transmission power optimizing unit 11g. These constituent elements are connected to one another in such a manner that signals and data can be input and output either in one direction or in two directions.

The initializing unit 11c initialize the power value, the resource allocation ratio, and the iteration variable by using Expressions (46) to (50) below. More specifically, the initializing unit 11c initializes the power value indicated in Expression (46) below so as to satisfy Expression (47) below, for example.

P⁽⁰⁾=[P₁⁽⁰⁾P₂⁽⁰⁾ . . . P_{N}⁽⁰⁾] (46)

P₁⁽⁰⁾=P₂⁽⁰⁾= . . . =P_{N}⁽⁰⁾=1 (47)

Further, the initializing unit 11c initializes the resource allocation ratio so as to satisfy Expression (48) and Expression (49) below, for example. Further, the initializing unit 11c initializes a variable t₁ serving as the iteration variable for the entire process to 0.

$$\begin{matrix}{ρ}_{i , k} = {ρ}_{i , k}^{( 0 )} , {ρ}_{i , k , l} = {ρ}_{i , k , l}^{( 0 )} & ( 48 ) \\ {ρ}_{i , k}^{( 0 )} = \frac{1}{K {+}_{K} {C}_{2}} , {ρ}_{i , k , l}^{( 0 )} = \frac{1}{K + {}_{K}^{}{C}{}_{2}^{}} & ( 49 )\end{matrix}$$

The throughput calculating unit 11d calculates the average SNR and the predicted average throughput mentioned above. More specifically, with respect to the iteration variable t₁, the throughput calculating unit 11d calculates the values of T_{i,k}, R_{i,k}, and Γ_{i,k} by using Expressions (38), (40), and (41) above, based on a Reference Signal Received Power value RSRP_{i,k,j} indicated in a notification from the uplink receiving unit 121h, the power value expressed with Mathematical Formula 56 below, and the resource allocation ratios expressed with Mathematical Formulae 57 and 58 below.

P^{(t}^{₁}⁻¹⁾

ρi,k^{(t}^{₁}⁻¹⁾

ρi,k,l^{(t}^{₁}⁻¹⁾

The power allocation optimizing unit 11e optimizes the power allocation for the inter-user non-orthogonal multiplexing. It is possible to obtain the optimal power allocation by using Expression (51) below, under the condition expressed in Expression (50) below, where k<l is satisfied.

$$\begin{matrix}\frac{\partial {u}_{i}}{\partial {p}_{i , k , l}} = 0 & ( 50 ) \\ {p}_{i , k , l} = \frac{{T}_{i , k} {Γ}_{i , 1} - {T}_{i , l} {Γ}_{i , k}}{{Γ}_{i , k} {Γ}_{i , l} ( {T}_{i , l} - {T}_{i , k} )} & ( 51 )\end{matrix}$$

The resource allocation ratio optimizing unit 11f optimizes the resource allocation ratio for each of the cells. The resource allocation ratio optimizing unit 11f performs the optimizing process by using, for example, a conditional gradient method or the like, while considering Pᵢ and p_{i,k,l} each as a constant. More specifically, the resource allocation ratio optimizing unit 11f defines a variable vector as ρᵢ indicated in Expression (52) below. Further, the resource allocation ratio optimizing unit 11f initializes the iteration variable t₂ to 0.

ρᵢ=└ρ_{i,1}ρ_{i,2} . . . ρ_{i,K}_{ᵢ}ρ_{i,1,2}ρ_{i,1,3} . . . ρ_{i,K}_{ᵢ}_{-1,K}_{ᵢ}┘ (52)

The resource allocation ratio optimizing unit 11f calculates a gradient vector by using Expression (54) below, while using the value expressed in Expression (53) below as the initial value of the resource allocation ratio. It is assumed that the relationships indicated in Expression (55) are satisfied.

$$\begin{matrix}{ρ}_{i , k}^{( {t}_{2} = 0 )} = {ρ}_{i , k}^{( {t}_{1} - 1 )} , {ρ}_{i , k , l}^{( {t}_{2} = 0 )} = {ρ}_{i , k , l}^{( {t}_{1} - 1 )} & ( 53 ) \\ ∇ {u}_{i} = [ \begin{matrix}\frac{\partial {u}_{i}}{\partial {ρ}_{i , 1}} & \frac{\partial {u}_{i}}{\partial {ρ}_{i , 2}} & … & \frac{\partial {u}_{i}}{\partial {ρ}_{i , {K}_{i}}} & \frac{\partial {u}_{i}}{\partial {ρ}_{i , 1 , 2}} & \frac{\partial {u}_{i}}{\partial {ρ}_{i , 1 , 3}} & … & \frac{\partial {u}_{i}}{\partial {ρ}_{i , {K}_{i} - 1 , {K}_{i}}}\end{matrix} ] & ( 54 ) \\ \frac{\partial {u}_{i}}{\partial {ρ}_{i , k}} = \frac{{R}_{i , k}}{{T}_{i , k}} \\ \frac{\partial {u}_{i}}{\partial {ρ}_{i , k , l}} = \frac{{R}_{i , k , l}}{{T}_{i , k}} + \frac{{R}_{i , l , k}}{{T}_{i , l }} & ( 55 )\end{matrix}$$

Subsequently, by using Expression (56) below, the resource allocation ratio optimizing unit 11f determines such an vertex of which the inner product with the abovementioned gradient vector is the largest from among the vertices in the feasible region, to be an updating direction.

$${d}^{( {t}_{2} )} = arg {max ( ∇ {u}_{i} )}^{T} {ρ}_{i} subject to \\ {\sum }_{k = 1}^{{K}_{i}} ( {ρ}_{i , k} + {\sum }_{l = k + 1}^{{K}_{i}} {ρ}_{i , k , l} ) = 1 , {ρ}_{i , k} \geq 0 , {ρ}_{i , k , l} \geq 0 \qquad ( 56 )$$

Subsequently, the resource allocation ratio optimizing unit 11f determines an updating step indicating the amount by which an advance is made in the updating direction, by using Expression (57) below.

ρᵢ^{(t}^{₂}⁾=(1−β^{λ})ρᵢ^{(t}^{₂}⁻¹⁾+β^{λ}d^{(t}^{₂}⁾ (57)

In Expression (57), λ denotes the smallest integer that satisfies Expression (58) below. Further, α and β are set values that are determined in advance.

uᵢ((1−β^{λ})ρᵢ^{(t}^{₂}⁻¹⁾+β^{λ}d^{(t}^{₂}⁾)−uᵢ(ρᵢ^{(t}^{₂}⁻¹⁾)≧αβ^{λ}(∇uᵢ)^{T}d^{(t}^{₂}⁾ (58)

Subsequently, the resource allocation ratio optimizing unit 11f performs a convergence test by using Expression (59) below. In other words, when Expression (59) is satisfied, the resource allocation ratio optimizing unit 11f ends the resource allocation ratio optimizing iteration process and determines the value calculated from Expression (57) above to be the resource allocation ratio. After that, the resource allocation ratio optimizing unit 11f notifies the cell transmission power optimizing unit 11g of the determined resource allocation ratio. On the contrary, when Expression (59) below is not satisfied, the resource allocation ratio optimizing unit 11f increments the variable t₂ by 1, and if the variable t₂ is smaller than or equal to τ₂, the process returns to the gradient vector calculating process described above. In Expression (59), ε is a set value determined in advance.

∥ρᵢ^{(t}^{₁}⁾−ρᵢ^{(t}^{₂}⁾∥²<ε (59)

The cell transmission power optimizing unit 11g optimizes the average cell transmission power level, while considering the inter-user power allocation determined by the power allocation optimizing unit 11e and the resource allocation ratio determined by the resource allocation ratio optimizing unit 11f each as a constant.

First, the cell transmission power optimizing unit 11g initializes a variable t₃ to 0 and initializes the power level corresponding to the variable t₃=0, as indicated in Expression (60) below.

P^{(t}^{₃}⁼⁰⁾=P^{(t}^{₃}⁻¹⁾ (60)

Subsequently, the cell transmission power optimizing unit 11g calculates a gradient vector by using Expression (61) below, where the relationships indicated in Expression (62) are satisfied.

$$\begin{matrix}∇ U ( {P}^{( {t}_{3} - 1 )} ) = {[ \begin{matrix}\frac{\partial U ( {P}^{( {t}_{3} - 1 )} )}{\partial {P}_{1}} & \frac{\partial U ( {P}^{( {t}_{3} - 1 )} )}{\partial {P}_{2 }} & … & \frac{\partial U ( {P}^{( {t}_{3} - 1 )} )}{\partial {P}_{N}}\end{matrix} ]}^{T} & ( 61 ) \\ \frac{\partial U}{\partial {P}_{{i}^{′}}} = {\sum }_{i = 1}^{N} \frac{\partial {u}_{i}}{\partial {P}_{{i}^{′ }}} \\ \frac{\partial {u}_{i}}{\partial {P}_{{i}^{′}}} = {\sum }_{k = 1}^{{K}_{i}} \frac{1}{{T}_{i , k}} \frac{\partial {T}_{i , k}}{\partial {P}_{{i}^{′}}} \\ \frac{\partial {T}_{i , k}}{\partial {P}_{{i}^{′}}} = {ρ}_{i , k} \frac{\partial {R}_{i , k}}{\partial {P}_{{i}^{′}}} + {\sum }_{l = k + 1}^{{K}_{i}} {ρ}_{i , k , l} \frac{\partial {R}_{i , k , l}}{\partial {P}_{{i}^{′ }}} + {\sum }_{l = 1}^{k - 1} {ρ}_{i , l , k} \frac{\partial {R}_{i , k , l}}{\partial {P}_{{i}^{′}}} \\ \frac{\partial {R}_{i , k}}{\partial {P}_{{i}^{′}}} = \frac{1}{1 + {Γ}_{i , k}} \frac{\partial {Γ}_{i , k}}{\partial {P}_{{i}^{′}}} \\ \frac{\partial {R}_{i , k , l}}{\partial {P}_{{i}^{′}}} = \frac{{p}_{i , k , l}}{1 + {p}_{i , k , l} {Γ}_{i , k }} \frac{\partial {Γ}_{i , k}}{\partial {P}_{{i}^{′ }}} , when k < l \\ \frac{\partial {R}_{i , k , l}}{\partial {P}_{{i}^{′}}} == \frac{1}{1 + {Γ}_{i , k}} \frac{1 - {p}_{i , k , l}}{1 + {p}_{i , k , l} {Γ}_{i , k}} \frac{\partial {Γ}_{i , k}}{\partial {P}_{{i}^{′ }}} , when k > l \\ \frac{\partial {Γ}_{i , k}}{\partial {P}_{{i}^{′ }}} = \frac{{Γ}_{i , k}}{{P}_{i}} , when {i}^{′} = i \\ \frac{\partial {Γ}_{i , k}}{\partial {P}_{{i}^{′}}} = - \frac{{RSRP}_{i , k , i} {P}_{i} {RSRP}_{i , k , {i}^{′}}}{{( {N}_{0} + {\sum }_{j = 1 , j \neq i}^{N} {RSRP}_{i , k , j} {P}_{j} )}^{2}} , i \neq {i}^{′} & ( 62 )\end{matrix}$$

Subsequently, by using Expression (63) below, the cell transmission power optimizing unit 11g determines such an vertex of which the inner product with the gradient vector is the largest from among the vertices in the feasible region, to be an updating direction. In Expression (63), P_{i,min} and P_{i,max} denote the minimum cell transmission power level and the maximum cell transmission power level with respect to the i-th cell transmission power level, respectively.

d^{(t}^{₃}⁾=arg max(∇U(P^{(t}^{₃}⁻¹⁾))^{T}P subject to P_{i,min}≦Pᵢ≦P_{i,max} (63)

Subsequently, by using Expression (64) below, the cell transmission power optimizing unit 11g determines an updating step indicating the amount by which an advance is made in the updating direction.

P^{(t}^{₃}⁾=(1−β^{λ})P^{(t}^{₃}⁻¹⁾+β^{λ}d^{(t}^{₃}⁾ (64)

In Expression (64), λ denotes the smallest integer that satisfies Expression (65) below. Further, α and β are set values that are determined in advance.

U((1−β^{λ})P^{(t}^{₃}⁻¹⁾+β^{λ}d)−U(P^{(t}^{₃}⁻¹⁾)≧αβ^{λ}(UF)^{T}d^{(t}^{₃}⁾ (65)

Subsequently, the cell transmission power optimizing unit 11g performs a convergence test by using Expression (66) below. In other words, when Expression (66) is satisfied, the cell transmission power optimizing unit 11g ends the iteration process described above and notifies the cell transmission power adjusting unit 121g provided at the following stage of the value P^{(t3)} indicated in Expression (64) above, as the transmission power level corresponding to the iteration variable t₁ for the entire process. On the contrary, when Expression (66) below is not satisfied, the cell transmission power optimizing unit 11g increments the variable t₃ by 1, and if the variable t₃ is smaller than or equal to τ₃, the process returns to the gradient vector calculating process described above. In Expression (66), ε is a set value determined in advance.

∥P^{(t}^{₃}⁺¹⁾−P^{(t}^{₃}⁾∥²<ε (66)

After that, when the iteration variable t₁ for the entire process is smaller than or equal to τ₁, the centralized controller 11 returns to the inter-user power allocation optimizing process and repeatedly performs the processes thereafter. However, at the point in time when the variable t₁ becomes larger than τ₁, the series of processes is ended.

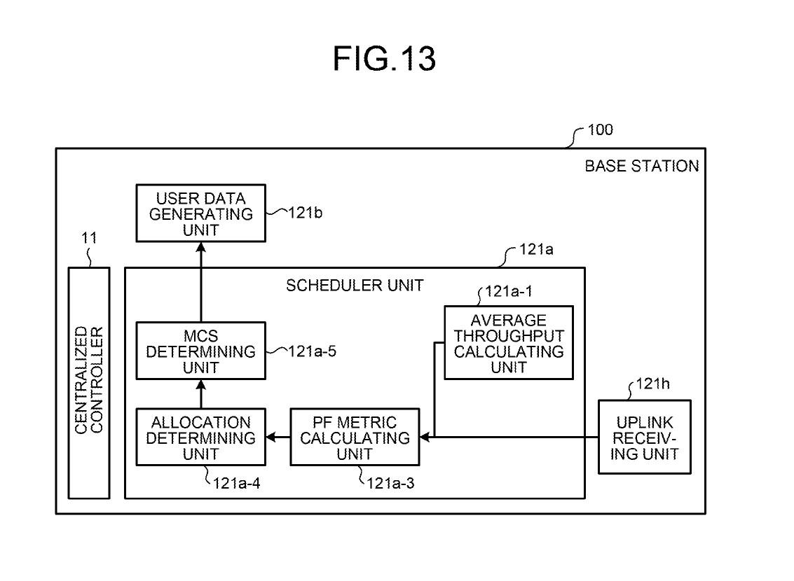

Next, a configuration of the scheduler unit 121a included in the base station 100 will be explained. FIG. 13 is a block diagram illustrating a functional configuration of the scheduler unit 121a included in the base station 100 according to the third embodiment. The scheduler unit 121a illustrated in FIG. 13 has almost the same configuration as that of the scheduler unit 121a according to the first embodiment illustrated in FIG. 4, except that the scheduler unit 121a according to the third embodiment is different from the scheduler unit 121a according to the first embodiment for not including the instantaneous SNR calculating unit 121a-2. In the third embodiment, because the wireless terminal 30 itself feeds back the SNR as a CSI value, the scheduler unit 121a included in the base station 100 according to the third embodiment does not need to include the instantaneous SNR calculating unit 121a-2. The MCS determining unit 121a-5 according to the third embodiment determines an MCS value of each of the wireless terminals 30 subject to the resource allocating process determined by the allocation determining unit 121a-4, based on the instantaneous throughput calculated by the PF metric calculating unit 121a-3.

The configuration of the wireless terminal 30 may be the same as that of the wireless terminal 30 according to the first embodiment. Thus, illustrations with drawings and detailed explanations thereof will be omitted. In each of the cells C1 to C7, the signal is transmitted by the transmission power level that has already been determined. For this reason, the wireless terminal 30 feeds back the SNR indicated in Expression (5) above to the base station 100 as a CSI value, by employing the CSI estimating unit 35 in correspondence with the configuration of the scheduler unit 121a described above.

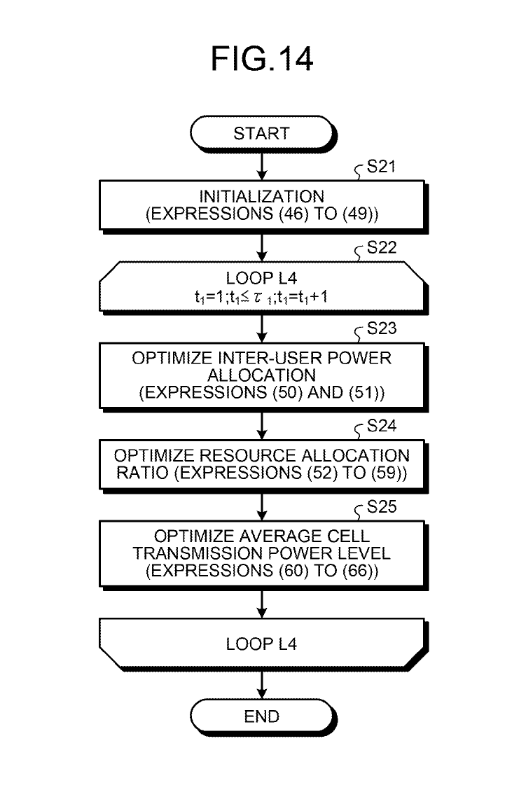

Next, operations will be explained. FIG. 14 is a flowchart for explaining an average cell transmission power optimizing process performed by the centralized controller 11 included in the base station 100 according to the third embodiment. First, the initializing unit 11c included in the centralized controller 11 initializes the power value and the resource allocation ratio by using Expressions (46) to (49) above (step S21). Subsequently, the power allocation optimizing unit 11e sets the iteration variable t₁ used for counting the number of times of iterations to the initial value “1” and executes a loop L4 for the first time (step S22).

Subsequently, the power allocation optimizing unit 11e optimizes the power allocation for the inter-user non-orthogonal multiplexing by using Expressions (50) and (51) above (step S23). After that, the resource allocation ratio optimizing unit 11f initializes the iteration variable t₂ to 0 and optimizes the resource allocation ratio for each of the cells, by using Expressions (52) to (59) above (step S24). Subsequently, the cell transmission power optimizing unit 11g optimizes the average cell transmission power level by using the inter-user power allocation determined by the power allocation optimizing unit 11e, the resource allocation ratio determined by the resource allocation ratio optimizing unit 11f, and Expressions (60) to (66) above (step S25).

The series of processes at steps S23 through S25 (the loop L4) is repeatedly performed until the transmission power control described above converges and is ended at the point of time when the transmission power control has converged. The average cell transmission power level that was optimized is indicated to the cell transmission power adjusting unit 121g in a notification from the cell transmission power optimizing unit 11g.

As described above, the cell transmission power controlling unit 11a included in the base station 100 according to the third embodiment calculates, for each of the cells C1 to C7, a first resource allocation ratio for the resources allocated to the plurality of wireless terminals 30 when the wireless terminals 30 are subject to the non-orthogonal multiplexing process (NOMA). Further, the cell transmission power controlling unit 11a calculates, for each of the cells C1 to C7, a second resource allocation ratio for the resources allocated to the plurality of wireless terminals 30 when the wireless terminals 30 are not subject to the non-orthogonal multiplexing process (NOMA). The cell transmission power controlling unit 11a determines and controls the transmission power level of each of the cells based on the first and the second resource allocation ratios. In the wireless communication system 1 according to the third embodiment, it is possible to realize the semi-static cell transmission power control with the longer control cycle. As a result, the base station 100 is able to reduce the processing load involved in the transmission power controlling process.

The optimized transmission power levels do not necessarily have to be applied to all the signals transmitted from the base station 100. In other words, the cell transmission power adjusting unit 121g included in the base station 100 may apply the transmission power levels determined at step S25 above only to the data signals, so that the pilot signals used by the wireless terminals 30 for estimating the CSI values are transmitted by using transmission power levels that are equal among the cells. In this mode, the wireless terminals 30 feed back the CSI values that are the same as those in the first embodiment, to the base station 100.

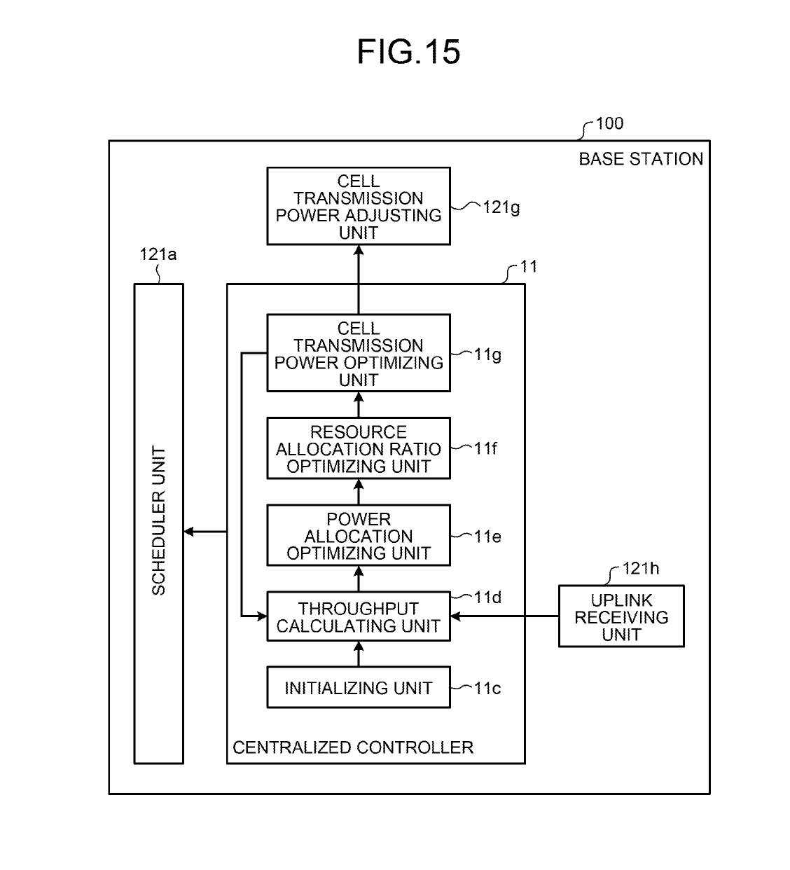

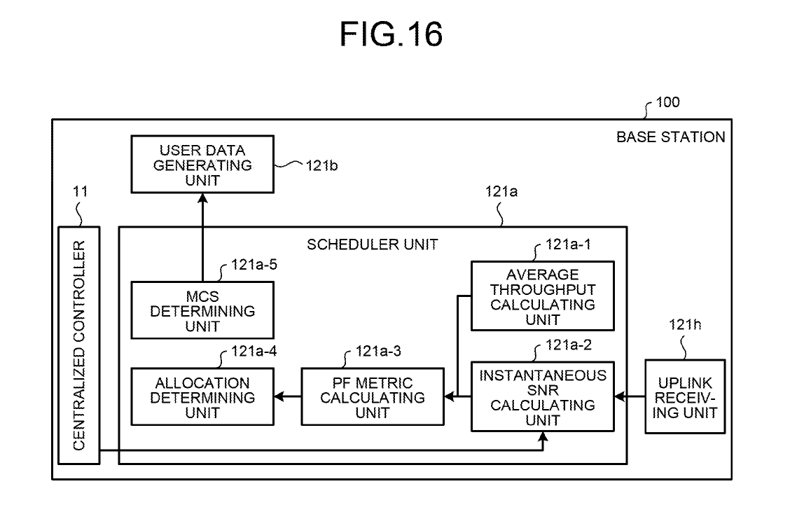

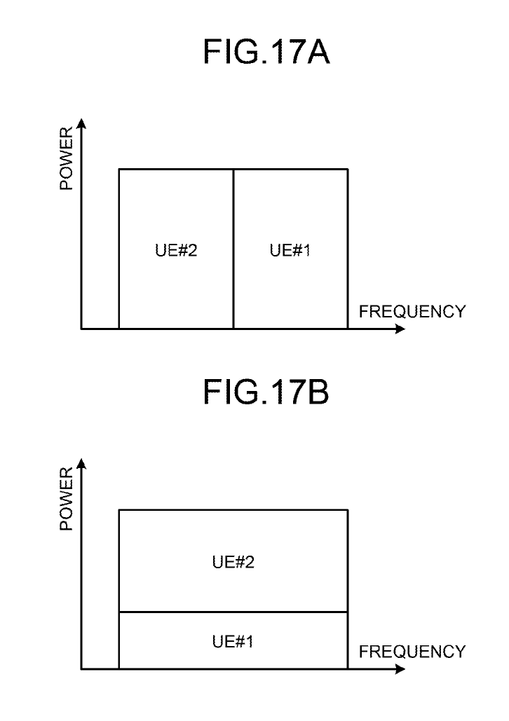

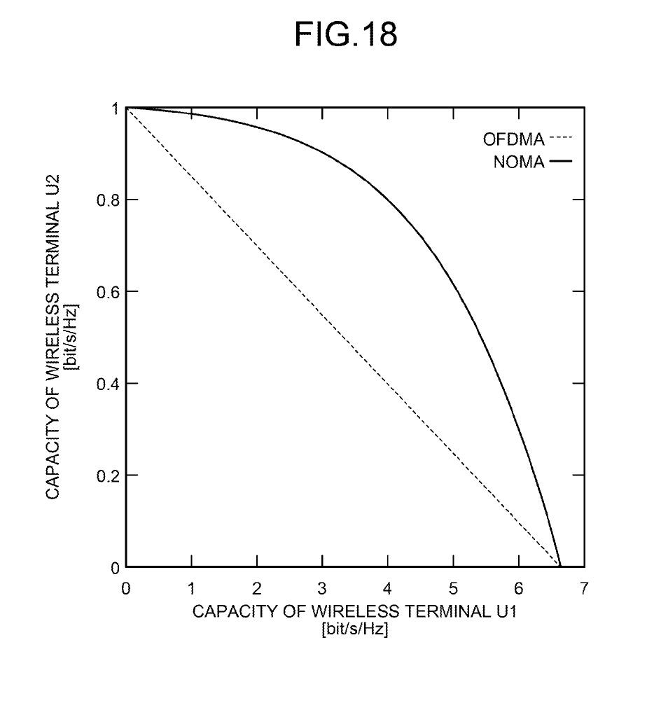

Further, in the mode described above, the centralized controller 11 and the scheduler unit 121a included in the base station 100 are configured as described below. FIG. 15 is a block diagram illustrating a functional configuration of the centralized controller 11 included in the base station 100 according to the present mode of the third embodiment. As illustrated in FIG. 15, the transmission power level determined by the cell transmission power optimizing unit 11g is indicated to the scheduler unit 121a in a notification from the centralized controller 11. FIG. 16 is a block diagram illustrating a functional configuration of the scheduler unit 121a included in the base station 100 according to the present mode of the third embodiment. As illustrated in FIG. 16, when having received the notification about the determined transmission power level from the centralized controller 11, the scheduler unit 121a calculates an instantaneous SNR by employing the instantaneous SNR calculating unit 121a-2, with the use of the transmission power level.

As explained above, the base station 100 determines whether or not the transmission power level is individually controlled for each of the cells C1 to C7, depending on the type of the signal transmitted from the base station 100 to the wireless terminals 30. For example, when the data signals are transmitted, the base station 100 controls the transmission power level individually for each of the cells C1 to C7. In contrast, when the pilot signals are transmitted, the base station 100 sets the transmission power level uniformly among the cells C1 to C7. With these arrangements, the processing amount of the base station 100 involved in the power controlling process is reduced, and the processing load is therefore also reduced, compared to the example in which the transmission power levels are individually controlled when any type of signal is transmitted. As a result, it is possible to implement the transmission power controlling process efficiently.

The example is explained above in which, in the wireless communication systems 1 in the exemplary embodiments and the modification examples, each of the plurality of RRHs 20a to 20g included in the single base station 100 forms a cell. However, the configuration of the wireless communication system 1 is not limited to this example. For instance, each of a plurality of base stations may form one cell. In that situation, one of the plurality of base stations may function as a master having the functions of the concentration controlling station 10 described in the exemplary embodiments and the modification examples above, so as to control the other base stations each functioning as a slave. Further, each of the wireless terminals does not have to be a portable phone but may be a tablet terminal, a smartphone, a Personal Digital Assistant (PDA), or the like. It is possible to apply the transmission power controlling technique of the wireless communication system 1 to any of various types of communication devices that perform wireless communication.

Further, in the exemplary embodiments and the modification examples described above, the CSI value is used as an example of the channel quality information reported to the base station 100 by the wireless terminals 30. However, the channel quality information reported to the base station 100 by the wireless terminals 30 may be a Channel Quality Indicator (CQI) value, for example. Further, as for the SNR and the RSRP value, a Signal to Interference Ratio (SIR) value or a Signal to Interference and Noise power Ratio (SINR) value may be used in place of the SNR or the RSRP value. Furthermore, a Received Signal Strength Indication (RSSI) value, a Reference Signal Received Quality (RSRQ) value, or the like may be used in place of the SNR or the RSRP value.

The constituent elements of the wireless communication system 1 according to any of the exemplary embodiments and the modification examples do not necessarily have to physically be configured as indicated in the drawings. In other words, the specific modes of allocation and integration of the apparatuses and the devices are not limited to those illustrated in the drawings. It is acceptable to functionally or physically distribute or integrate all or a part of the apparatuses and the devices in any arbitrary units, depending on various loads and the status of use. For example, the cell transmission power controlling unit 11a and the power allocation re-optimizing unit 11b illustrated in FIG. 5 may be integrated together as one constituent element. Conversely, the cell transmission power controlling unit 11a may be distributed, for example, into a section that determines the transmission power level for each of the cells and a section that actually controls the transmission power levels. Further, the storage device 100b may be connected via a network or a cable as an external device of the base station 100.

Further, in the description above, the individual configurations and operations are explained for each of the individual exemplary embodiments and modification examples. However, each of the wireless communication systems 1 according to the exemplary embodiments and the modification examples may also include any of the constituent elements that are specific to any other embodiment or modification example. It is also acceptable to combine any of the exemplary embodiments and the modification examples together in any arbitrary mode, such as combining not only two examples but also three or more examples. For example, the alternate execution function according to the first modification example and the approximating function according to the second modification example are each applicable not only to the first embodiment, but also to the second or the third embodiment. Further, the function of applying and not applying the individual power control depending on the type of signals is applicable not only to the third embodiment, but also to the first or the second embodiment. Furthermore, the single wireless communication system 1 may also include all the constituent elements explained in the first to the third embodiments and the first and the second modification examples described above, as long as the constituent elements are able to function without conflicting with one another.

According to at least one aspect of the wireless communication system, the base station, the wireless terminal, and the processing method implemented by the base station disclosed herein, it is possible to enhance the degree of fairness in the communication opportunities among the wireless terminals in the plurality of cells.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication system comprising a base station and a plurality of wireless terminals that are capable of wirelessly communicating with the base station, wherein
the base station includes:
a plurality of wireless apparatuses that form a plurality of cells; and
a first processor configured to execute a first process including: first determining a transmission power level for each of the cells in such a manner that a value obtained by totaling values of indexes for the plurality of cells becomes largest, the indexes each indicating a degree of fairness in communication opportunities among wireless terminals in a corresponding one of the plurality of cells, and
each of the plurality of wireless terminals includes:
a second processor configured to execute a second process including receiving, in a cell in which wireless terminals are present, a signal from each of the plurality of wireless apparatuses by using the transmission power level of the cell determined at the first determining.

2. The wireless communication system according to claim 1, wherein the first process further includes second determining allocation among the plurality of wireless terminals for the transmission power level determined for each of the cells at the first determining, with respect to the plurality of wireless terminals that are present in each of the cells and are non-orthogonally multiplexed with one another during a non-orthogonal multiplex communication.

3. The wireless communication system according to claim 2, wherein the first process further includes alternately executing a process of determining the transmission power level for each of the cells performed at the first determining and a process of determining the allocation among the plurality of wireless terminals performed at the second determining.

4. The wireless communication system according to claim 1, wherein the receiving includes transmitting, after receiving the signal, channel quality information to the base station by each of the plurality of wireless terminals transmits, the channel quality information being approximated by an average interference amount from the cells other than the cell in which the each wireless terminal is present.

5. The wireless communication system according to claim 1, wherein each of the plurality of wireless apparatuses included in the base station transmits and receives the signal to and from each of the plurality of wireless terminals by implementing a Multiple-Input and Multiple-Output (MIMO) method.

6. The wireless communication system according to claim 1, wherein the first process includes determining the transmission power level for each of the cells based on a first resource allocation ratio corresponding to when the plurality of wireless terminals are subject to non-orthogonal multiplexing and a second resource allocation ratio corresponding to when the plurality of wireless terminals are not subject to the non-orthogonal multiplexing.

7. A base station capable of wirelessly communicating with a plurality of wireless terminals, the base station comprising:
a plurality of wireless apparatuses that form a plurality of cells; and
a processor configured to execute a process including: determining a transmission power level for each of the cells in such a manner that a value obtained by totaling values of indexes for the plurality of cells becomes largest, the indexes each indicating a degree of fairness in communication opportunities among wireless terminals in a corresponding one of the plurality of cells, wherein
each of the plurality of wireless apparatuses transmits, in a cell in which wireless terminals are present, a signal to the plurality of wireless terminals, by using the transmission power level determined for the cell at the determining.

8. A wireless terminal capable of wirelessly communicating with a base station, the wireless terminal comprising:
a processor configured to execute a process including: receiving a signal from a wireless apparatus forming a cell in which the wireless terminal is present, by using a cell transmission power level determined in such a manner that a value obtained by totaling values of indexes for a plurality of cells becomes largest, the indexes each indicating a degree of fairness in communication opportunities among wireless terminals in a corresponding one of the plurality of cells formed by a plurality of wireless apparatuses included in the base station.
